(19) United States
(12) Patent Application Publication
(10) Pub. No.: US 2015/0012140 A1
(43) Pub. Date: Jan. 8, 2015

(54) MOTOR DRIVE CONTROLLER

(71) Applicant: Pteris Global Limited, Singapore (SG)

(72) Inventors: Xingming Fang, Singapore (SG); Kok Leng Lim, Singapore (SG); La Pyi Wunn Kyaw, Singapore (SG); Xuepei Wu, Singapore (SG); Hejin Yang, Singapore (SG)

(73) Assignee: Pteris Global Limited, Singapore (SG)

(21) Appl. No.: 14/281,491

(22) Filed: May 19, 2014

(30) Foreign Application Priority Data
Jul. 4, 2013 (SG) 201305198-2

(51) Int. Cl. G05B 15/02

(52) U.S. Cl. CPC G05B 15/02
USPC 700/275

(57) ABSTRACT

According to one aspect, there is provided a motor drive controller for use in a network of motor drive controllers, the motor drive controller comprising: a sensor configured to detect a status of a network controller controlling operation of the network of motor drive controllers; and a processor configured to enter into a slave operation mode, in which the processor receives operating instructions from the network controller, or a master operation mode, in which the processor provides operating instructions to the network of motor drive controllers, wherein the processor is further configured to receive the status of the network controller from the sensor and select the master operation mode when the network controller is inactive.

### RELATED APPLICATION

This application claims priority to Singapore Patent Application No. 201305198-2, filed Jul. 4, 2013 and titled “MOTOR DRIVE CONTROLLER”, said application in its entirety being hereby incorporated by reference into the present specification.

### FIELD

Various embodiments relate to a motor drive controller for use in a network of motor drive controllers.

### BACKGROUND

In a mechanical system, such as a conveyor system, many motors are involved. A motor is driven by a corresponding drive and a group of motors are supervised by a PLC (Programmable Logic Controller) unit.

A motor starter box has been used to drive a motor. A motor starter box has circuit breakers, output relays and slave communication I/O (input/output) units. Commands from a PLC unit instruct the slave output units to start or stop a motor by activating and deactivating the output relays. The PLC unit gets input signals from field devices such as sensors and encoders via the slave input units.

Inverters were then added to the motor starter box. Size and design complexity of the motor starter box depended on the inverter size and its application.

Thereafter, compact motor drives were introduced to drive a motor up to a rated power, typically 7.5 kW. These motor drives had inverter functions, slave communication, I/O interfaces and motor starter box functions. An example would be IP65 rated motor drives

However, such motor drives are merely slave units, supervised by a central control unit, such as a Programmable Logic Controller (PLC) unit. With one PLC unit controlling 50 or more slave units in a zone of a system, a heavy control burden is placed on the PLC unit, slowing down system operation. Further, should the PLC unit fail; the network of motor drives connected to the PLC unit will also not work.

There is also inflexibility in selecting a PLC unit to control motors, as a PLC unit has to be compatible with the motor drives used in a mechanical system.

Lastly, motor drives are susceptible to heat, since their components are operating at high powers. With motor drives being fully enclosed devices, there needs to be an efficient way to reduce heat generated during motor drive operation.

There is thus a need to address the above problems.

### SUMMARY

According to a first aspect, there is provided a motor drive controller for use in a network of motor drive controllers, the motor drive controller comprising: a sensor configured to detect a status of a network controller controlling operation of the network of motor drive controllers; and a processor configured to enter into a slave operation mode, in which the processor receives operating instructions from the network controller, or a master operation mode, in which the processor provides operating instructions to the network of motor drive controllers, wherein the processor is further configured to receive the status of the network controller from the sensor and select the master operation mode when the network controller is inactive.

According to a second aspect, there is provided a network of motor drive controllers comprising one or more separate sub-systems of motor drive controllers, wherein each of the separate sub-systems comprises a plurality of interconnected motor drive controllers; and a network controller connected to the one or more separate sub-systems of motor drive controllers, the network controller configured to provide operating instructions to all of the interconnected motor drive controllers, wherein one or more of the motor drive controllers within each of the one or more separate sub-systems of motor drive controllers is configured to provide operating instructions to each of the other plurality of interconnected motor drive controllers within the respective sub-system of motor drive controllers when the network controller is inactive.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a block diagram representation of a motor drive controller according to one embodiment.

FIG. 2A shows the motor drive controller of FIG. 1 in a slave operation mode.

FIG. 2B shows the motor drive controller of FIG. 1 in a master operation mode.

FIG. 2C shows a flow chart that a processor of the motor drive controller of FIG. 1 follows.

FIG. 3 shows an isometric view of a motor drive controller according to one embodiment.

FIG. 4 shows a top perspective view of a lower portion of the motor drive controller of FIG. 3.

FIG. 5 shows an exploded view, from the bottom, of the upper portion of the motor drive controller of FIG. 3.

FIG. 6 shows an exploded view, from the top, of the upper portion of the motor drive controller of FIG. 3.

FIG. 7 shows an exploded view of the motor drive controller of FIG. 3.

FIG. 8 shows a schematic of control parameter management that is employed by the motor drive controller of FIGS. 3 to 7.

FIG. 9 shows a schematic illustrating data exchange between controllers shown in FIG. 8.

FIG. 10 shows a schematic of the motor drive controller of FIGS. 3 to 7.

FIGS. 11A and 11B each show a schematic layout of the hardware of the motor drive controller of FIGS. 3 to 7.

FIG. 12 shows the architecture of a high voltage power board of the motor drive controller of FIG. 3.

FIG. 13 shows the architecture of a central control processor board of the motor drive controller of FIG. 3.

FIG. 14 shows the architecture of a communications board of the motor drive controller of FIG. 3.

FIGS. 15A and 15B each show the architecture of a human machine interface board of the motor drive controller of FIG. 3.

FIG. 16 shows an architecture of a controller of the central control processor board shown in FIG. 13.

### DEFINITIONS

The following provides sample, but not exhaustive, definitions for expressions used throughout various embodiments disclosed herein.

The term “motor drive controller” may refer to a controller that is used to control operation of one or more motors used for mechanical systems, such as for baggage handling, automation, process control and conveyor.

The term “network” may mean a plurality of motor drive controllers being organised into one or more separate groups or zones, with each zone termed as a sub-system. The motor drive controllers in each sub-system are interconnected. A network controller is connected to each of the motor drive controllers in each sub-system.

The term “status of a network controller” may mean whether a network controller is active, where the network controller is providing operating instructions to the motor drive controller; or inactive, where the network controller is not providing operating instructions to the motor drive controller or the motor drive controller is not receiving the operating instructions from the network controller. A “network controller” may mean a main controller that is responsible for controlling the operation of the motor drive controller, along with any other motor drive controllers in a network, so that the network controller becomes a primary controller and the motor drive controller is a secondary controller.

The term “operating instructions” may mean parameters which are required for each of the components in the motor drive controller to perform their specific function. The operating instructions the processor receives in the slave operation mode may be those received when control of the network of motor drive controllers lies with the network controller. The operating instructions the processor receives in the master operation mode may be an indication that the motor drive controller is designated to issue commands to other motor drive controllers that are within the same sub-system as the motor drive controller, i.e. the other motor drive controllers refer to the designated motor drive controller for commands to continue with their assigned functions.

### DETAILED DESCRIPTION

Various embodiments provide for a motor drive controller that provides an inverter function, is compatible with several field-bus communication protocols, is preloaded with self control logic (i.e. being pre-programmed with instructions that allow the motor drive controller to provide, without input from a network controller, one or more connected motor drives with basic control functions—such as start, stop, forward run, reverse run and speed change—and critical control functions, which for baggage handling applications include cascade start/stop, die-back, power-save, bag gap control, merge and divert), has a programmable logic controller and also functions as a motor starter box. There are four aspects to such a motor drive controller, namely its hardware architecture; the manner in which it functions in a network, its software architecture and its casing structure having a cooling arrangement.

The hardware architecture is designed to allow the motor drive controller to be compatible with available PLC (programmable logic controller) units using communication protocol such as Ethernet/IP, EtherCAT, ProfiNet, ProfiBus and ASi-bus. The hardware architecture is also designed to provide remote control of the motor drive controller through two communication mediums, infrared and wireless protocol (such as over a 433 MHz bandwidth), between the motor drive controller and portable conventional hand held remote control units, such as HMI (human machine interface) devices. Infrared communication is used to give a handshake signal at the start of operating a hand held portable HMI device. Once the handshake signal is successful, wireless communication is used to access the motor drive controller to perform tasks such as: 1) configuring parameters; 2) sending motor control commands such as start, stop, forward run, reverse run, etc; and 3) obtaining a present status of the motor drive controller such as current, voltage etc. The motor drive controller is designed to provide an internal integrated 24 VDC power supply to connected field devices such as sensors, brake, etc and thereby avoid reliance on a centralized external power supply, which may be unstable and cause power drop. When used in a network of motor drive controllers, the motor drive controller, according to various embodiments, is able to detect whether it operates in a main network mode or a secondary network mode. The main network mode, which occurs when the main PLC is active, sees operation between motor drive controllers and each of their respectively connected field devices, with a main PLC retaining supervisory control of all the motor drive controllers. The secondary network mode, which occurs when the main PLC fails or is inactive, sees operation between motor drive controllers within a sub-system, with the motor drive controllers controlling each of their respectively connected field devices and a designated one of the motor drive controllers assumes supervisory control.

The motor drive controller has intelligent functions such as a self control logic function (supported during main network and secondary network operation) and a configurable master control function (supported by secondary network operation).

The self control logic function has the motor drive controller deciding basic as well as critical control functions (see earlier for examples of basic and critical control functions) by itself, without input from the main PLC. In a preferred embodiment, these basic and critical control functions are implemented when the motor drive controller is in the main network mode or the secondary network mode. Thus, the main PLC just needs to concentrate on system control functions such as system start/stop, monitoring the status of the connected motor drive controllers, load distribution and other communication between the motor drive controllers and higher level control. As a result, control burden of a main PLC is reduced and operating cycle is faster compared to if the PLC were to be connected to a conventional motor drive controller without such self control logic.

The configurable master function occurs when a communication sensor of the motor drive controller senses that a main network controller or a central PLC has failed, whereby the motor drive controller becomes a designated motor drive controller within a sub-system of motor drive controllers that the designated motor drive controller belongs. The designated motor driver controller takes over the control responsibility of the central PLC to the other motor drive controllers of the sub-system, until the central PLC is replaced. For each of the sub-systems that the central PLC controls, one of its motor drive controllers will be such a designated motor drive controller.

The software architecture of the motor drive controller has five aspects, namely operation parameter management, data exchange mechanism, power management, communication configuration and logic function.

Unlike prior motor drive controllers, operation parameters are distributed across separate memory blocks managed by respective controllers for more time efficient data exchange. The data exchange mechanism employed by the motor drive controller, according to various embodiments, uses cyclic and acyclic data exchange between these controllers.

A power management system is implemented which automatically cuts all power supply, except to critical power supply, once an emergency stop is applied. Critical power supply means, for instance, power supply to an encoder, of which feedback data is essential for a system of motor drive controllers.

Implemented communication configuration allows the motor drive controller, according to various embodiments, to use standardized field-bus connector ports. Four physical connector ports may be used: a first port catered for AS-i (Actuator Sensor Interface) communication; a second port catered for CAN Bus communication; a third port catered for Profibus; and a fourth port catered for 1) Profinet, 2) EtherCAT and 3) Ethernet/IP communication. In the case of the first port, a connector such as M8 or M12 may be used for AS-i bus connection; for the second port, a connector such as D-sub type may be used for CAN bus connection; and for the third port, a connector such as D-sub type may be used for Profibus connection. For the fourth port, a pair of RJ45 connectors may be used for Profinet connection or EtherCAT connection or Ethernet UP connection. The implemented communication configuration allows the motor drive controller to utilise the appropriate communication protocol to base communication with any one of the respective four ports that are in use.

The fifth aspect of the software architecture, namely logic function refers to the motor drive controller having pre-programmed logic function and programmable logic function. The pre-programmed logic function includes self control logic (also see above) written in a syntax that is compatible with proprietary software employed in mechanical systems (such as a conveyor system) where the motor drive controller according to various embodiments is to be used. Self control logic function includes basic as well as critical commands that are used in such mechanical systems. If the pre-programmed self control logic is not compatible with the logic employed in the system where the motor drive controller according to various embodiments is to be used, the programmable logic function can be used to create compatible logic, so that the motor drive controller can be used. Programmable logic function is customisable according to a specific requirement, using any one of 5 programming languages such as ladder diagram, instruction list, structure text, function block and sequential function chart.

The casing/housing of the motor drive controller, according to various embodiments, may be made from light material, preferably aluminium casting. It is designed to be two separable modular units, such as having electronics placed in a top unit and wiring placed in a bottom unit. If the electronics break down, the upper unit is replaced with a new one. Unlike other known motor drive controllers, the whole unit is required to be replaced and rewired again when their electronics fail. The motor drive controller according to various embodiments is designed such that when one of them is removed, a network of motor drive controllers to which the motor drive controller is connected will still continue to operate. This facilitates onsite maintenance. The casing/housing is also provided with a cooling arrangement to distribute heat generated during operation of the motor drive controller.

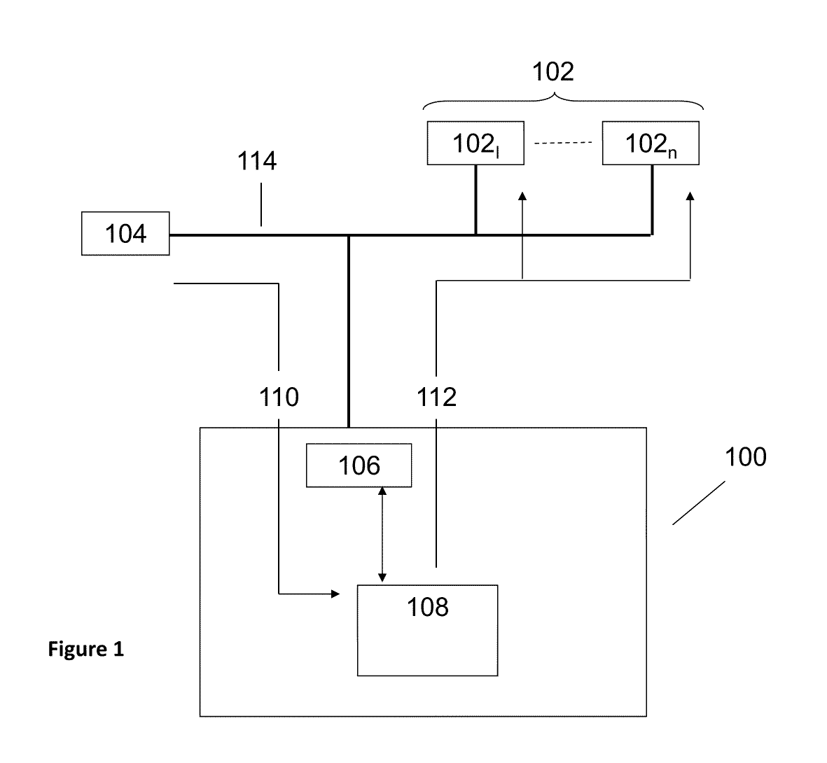

FIG. 1 shows a block diagram representation of a motor drive controller 100 according to one embodiment.

The motor drive controller 100 is for use in a network 102 of motor drive controllers (102₁, . . . , 102ₙ). The motor drive controller 100 comprises: a sensor 106 and a processor 108. The sensor 106 is configured to detect a status of a network controller 104 controlling operation of the network 102 of motor drive controllers (102₁, . . . , 102ₙ). The processor 108 is configured to enter into a slave operation mode, in which the processor receives operating instructions from the network controller (depicted by the arrow labelled using reference numeral 110), or a master operation mode, in which the processor 108 provides operating instructions to the network of motor drive controllers (depicted by the arrow labelled using reference numeral 112), wherein the processor 108 is further configured to receive the status of the network controller 104 from the sensor 106 and select the master operation mode when the network controller 104 is inactive.

In a preferred embodiment, the motor drive controller 100, the network controller 104 and the network 102 of motor drive controllers (102₁, . . . , 102ₙ) are connected by a field bus 114.

In the preferred embodiment, the motor drive controller 100 is adapted to be compatible with the network 102 of motor drive controllers (102₁, . . . , 102ₙ), i.e. the operating instructions provided by the motor drive controller 100 to the network 102 is processed and implemented by each motor drive controller (102₁, . . . , 102ₙ). Further, the motor drive controller 100 is compatible with the network controller 104, i.e. the motor drive controller 100 processes and implements instructions received by the network controller 104. This is achieved by the processor 108 being configured to process and issue operating instructions that are compliant with, but not limited to, any one or more of the protocols Ethernet/IP, EtherCAT, ProfiBus and ProfiNet.

The motor drive controller 100 ensures that the network 102 of motor drive controllers (102₁, . . . , 102ₙ) still remains in operation should a fault develop in the network controller 104 that causes the network controller 104 to become inactive or should the network 102 of motor drive controllers (102₁, . . . , 102ₙ) be unable to receive operating instructions from the network controller 104. Thus, various embodiments allow for a network of motor drive controllers to still operate should a network controller malfunction.

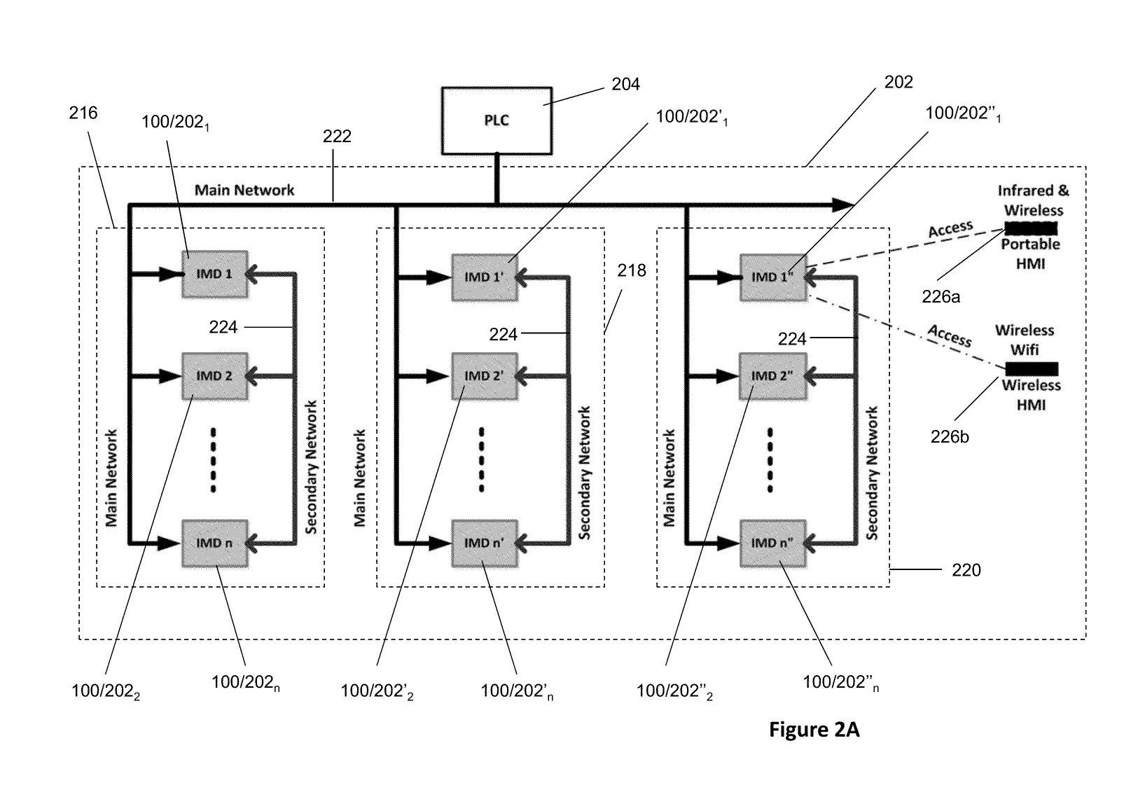

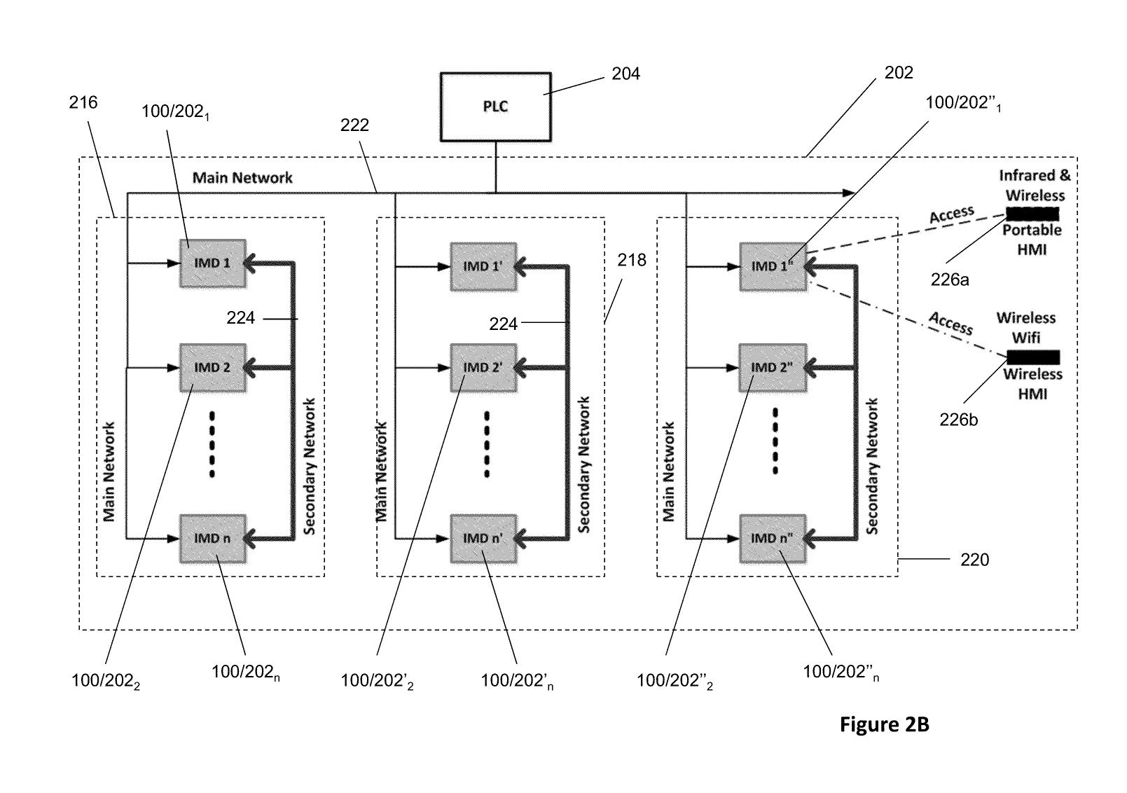

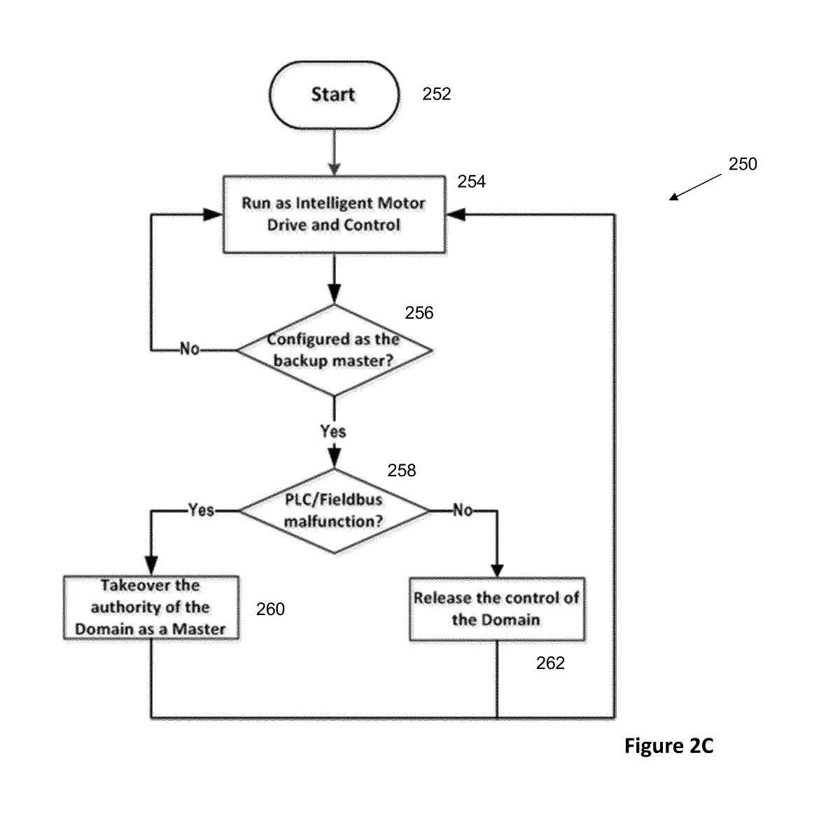

FIGS. 2A and 2B show block diagram representations of a network 202 of motor drive controllers (202₁, . . . , 202ₙ), wherein the embodiments shown in FIGS. 2A and 2B, are each the motor drive controller 100 of FIG. 1.

The network 202 of motor drive controllers comprises one or more separate sub-systems (or groups) of motor drive controllers, wherein each sub-system (216, 218 and 220) comprises a plurality of interconnected motor drive controllers (202₁, 202₂, . . . , 202ₙ for the first sub-system 216; 202′₁, 202′₂, . . . , 202′ₙ for the second sub-system 218; and 202″₁, 202″₂, . . . , 202″ₙ for the third sub-system 220). A network controller 204 is connected to the one or more sub-system (216, 218 and 220), the network controller 204 configured to provide operating instructions to all of the interconnected motor drive controllers. One or more of the motor drive controllers (202₁, 202₂, . . . , 202ₙ; 202′₁, 202′₂, . . . , 202′ₙ; and 202″₁, 202″₂, . . . , 202″ₙ) within each of the one or more sub-system (216, 218 and 220) is configured to provide operating instructions to each of the other plurality of interconnected motor drive controllers within the respective sub-system (i.e. one of the sub-system 216, 218 and 220) when the network controller 204 is inactive. The exact number of sub-systems (216, 218 and 220) and the number of motor drive controllers 100 in each sub-system (216, 218 and 220) may vary on the capability of the network controller 204 that is selected.

The hybrid capability of the motor drive controller 100 (i.e. the motor drive controller being able to operate in either a slave mode or a master mode) finds applications in mechanical systems. In such an embodiment, the network controller 204 acts as a PLC (programmable logic controller) having supervisory control over zones of mechanical systems, represented by the sub-systems 216, 218 and 220. Under supervisory control, operating instructions received from the network controller 204 include an indication that the network controller 204 retains control of the operation of the network 202 of motor drive controllers 100 when the network controller 204 is active. The operating instructions provided to the network 202 of motor drive controllers 100 include an indication that the motor drive controllers 100 control the operation of the network 202 when the network controller 204 is inactive, more specifically, that an assigned one of the motor drive controllers 100 controls the operation of the sub-system (216, 218 and 220) to which the assigned motor drive controller belongs.

In FIGS. 2A and 2B, the motor drive controllers 100 under sub-systems (216, 218 and 220) and the network controller 204 form a main network connected by a field bus 222, where any kind of field bus communication is used to transmit data between each motor drive controller 100 under sub-systems (216, 218 and 220) and the network controller 204. Each respective sub-system (216, 218 and 220) forms a secondary network, where within each group, a secondary bus 224 interconnects each of the respective motor drive controller (202₁, 202₂, . . . , 202ₙ; 202′₁, 202′₂, . . . , 202′ₙ; and 202″₁, 202″₂, . . . , 202″ₙ). The secondary network may use any CAN (controller area network) bus communication protocol for transmitting data between the respective motor drive controllers (202₁, 202₂, . . . , 202ₙ; 202′₁, 202′₂, . . . , 202′ₙ; and 202″₁, 202″₂, . . . , 202ₙ).

Portable devices 226a and 226b provide an operation mode to access each of the motor drive controllers (202₁, 202₂, . . . , 202ₙ; 202′₁, 202′₂, . . . , 202′ₙ; and 202″₁, 202″₂, . . . , 202ₙ), allowing a user with an external means to change and to read operation characteristics of the motor drive controllers (202₁, 202₂, . . . , 202ₙ; 202′₁, 202′₂, . . . , 202′ₙ; and 202″₁, 202″₂, . . . , 202″ₙ). The motor drive controllers (202₁, 202₂, . . . , 202ₙ; 202′₁, 202′₂, . . . , 202′ₙ; and 202″₁, 202″₂, . . . , 202″ₙ) may start the operation after receiving a handshake signal from an infrared port in the portable device 226a. The motor drive controllers (202₁, 202₂, . . . , 202ₙ; 202′₁, 202′₂, . . . , 202′ₙ; and 202″₁, 202″₂, . . . , 202″ₙ) may also have a wireless transceiver to wirelessly transmit and receive operation parameters with the portable device 226b for the user to monitor the operation status of the motor drive controllers (202₁, 202₂, . . . , 202ₙ; 202′₁, 202′₂, . . . , 202′ₙ; and 202″₁, 202″₂, . . . , 202″ₙ). Thus, the portable devices 226a and 226b provide a human machine interface (HMI).

FIG. 2A shows the motor drive controller 100 in a slave operation mode (i.e. when the network controller 204 is active). Both main fieldbus 222 and secondary fieldbus 224 are active when the network controller 204 is active, so that main network control between the network controller 204 and all the motor drive controllers (202₁, 202₂, . . . , 202ₙ; 202′₁, 202′₂, . . . , 202′ₙ; and 202″₁, 202″₂, . . . , 202″ₙ) is in operation.

The motor drive controller 100 receives system control functions such as sub-system start/stop, motor drive controller status monitoring, load distribution; and other communication sent by a supervisory controller (not shown) to the network controller 204. The processor of the motor drive controller 100 is further configured to communicate with one or more connected motor drives (not shown) for control of the one or more connected motor drives independent from the network controller 204. This independent control provides each motor drive controller 100 with self control logic functions, which vary depending on the type of application. For example in conveyor system of material handling, these self control logic functions include cascade start/stop, die-back, power save, bag gap control, merge and divert. The communication between the processor and the one or more connected motor drives to the motor drive controller 100 includes the status of the one or more connected motor drives; and motor control commands that include any one or more of the following: start, stop, forward run and reverse run.

These functions and other different controls are pre-programmed into the processor (see 108 of FIG. 1) of the motor drive controller 100 and are not received from the network controller 204. Thus, the motor drive controller 100 does not rely on the network controller 204 for commands that relate to major control functions or tasks, as they are already preprogrammed as self control logic in the motor drive controller 100. Preprogrammed tasks are independently managed by each motor drive controller 100, with information about the status of these tasks being communicated between one or more of the motor drive controllers 100 and feedback being provided to the network controller 204. The status of these tasks may be sent from the network controller 204 to another supervisory controller (not shown). Vice versa, commands from the supervisory controller are passed by the network controller 204 to one or more of the motor drive controllers 100. In this way, the network controller 204 becomes a mediator between one or more of the motor drive controllers 100 and the supervisory controller. Thus, the network controller 204 has light control duty. As a consequence, the network controller 204 can control more motor drive controllers (i.e. more motor drive controllers 100 according to various embodiments), since there is less payload on the processing capabilities of the network controller 204.

FIG. 2B shows the motor drive controller 100 in a master operation mode (i.e. when the network controller 204 is inactive). This may occur when there is a malfunction in the network controller 204 or the motor drive controllers (202₁, 202₂, . . . , 202ₙ; 202′₁, 202′₂, . . . , 202′ₙ; and 202″₁, 202″₂, . . . , 202″ₙ) are not receiving instructions from the network controller 204.

A thicker line is used for the secondary bus 224 (compare with the line used for the field bus 222) to represent that the network controller 204 is inactive, so that secondary network control between the motor drive controllers (202₁, 202₂, . . . , 202ₙ; 202′₁, 202′₂, . . . , 202′ₙ; and 202″₁, 202″₂, . . . , 202″ₙ) is in operation, wherein a designated motor drive controller 100 controls the operation of the other interconnected motor drive controllers (202₁, 202₂, . . . , 202ₙ; 202′₁, 202′₂, . . . , 202′ₙ; and 202″₁, 202″₂, . . . , 202″ₙ). In this way, operation of the network 202 continues until the network controller 204 is replaced. Under secondary network, the designated motor drive controller 100 becomes a master controller to the other plurality of motor drive controllers (202₁, 202₂, . . . , 202ₙ; 202′₁, 202′₂, . . . , 202′ₙ; and 202″₁, 202″₂, . . . , 202″ₙ) within its respective sub-system (216, 218 and 220).

FIG. 2C shows a flow chart 250 that the processor 108 of the motor drive controller of FIG. 1 follows.

The flowchart begins at step 252, where with reference to FIGS. 2A and 2B a designated motor drive controllers 100 within each sub-system (216, 218 and 220) may be preset to act as a master controller that takes over operation of the other connected motor drive controllers (202₁, 202₂, . . . , 202ₙ; 202′₁, 202′₂, . . . , 202′ₙ; and 202″₁, 202″₂, . . . , 202″ₙ) within its respective sub-system (216, 218 and 220), should the network controller 204 fail.

In step 254, operation of the motor drive controllers 100 begins. In step 256, each of the motor drive controllers 100 determines whether it has been preset to be the master controller. The motor drive controllers 100 that are not preset to be the master controller maintain step 254 while the motor drive controllers 100 that are preset to be the master controller proceed to step 258, where it is determined whether there is malfunction in the network controller 204. Should there be a malfunction, the motor drive controllers 100 that are preset to be the master controller take over control of their respective sub-system of motor drive controllers (216, 218 and 220), from the network controller 204, in step 260. If the motor drive controllers 100 that are preset to be the master controller still receive commands from the network controller 204, network 202 control is released to the network controller 204 in step 262.

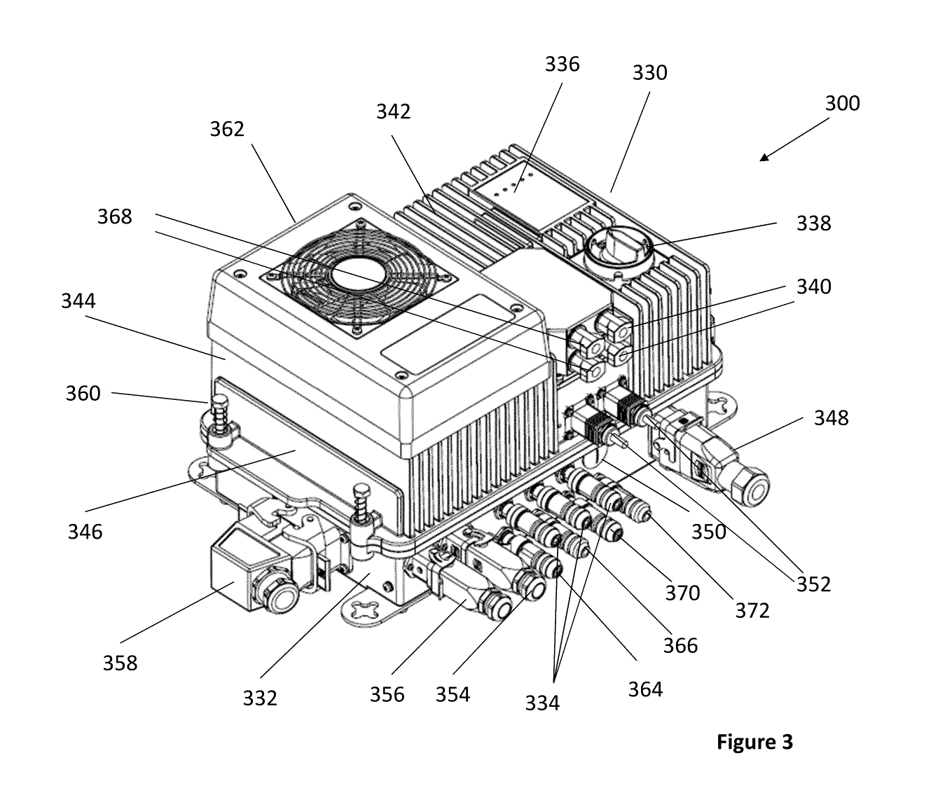

FIG. 3 shows an isometric view of a motor drive controller 300 according to one embodiment.

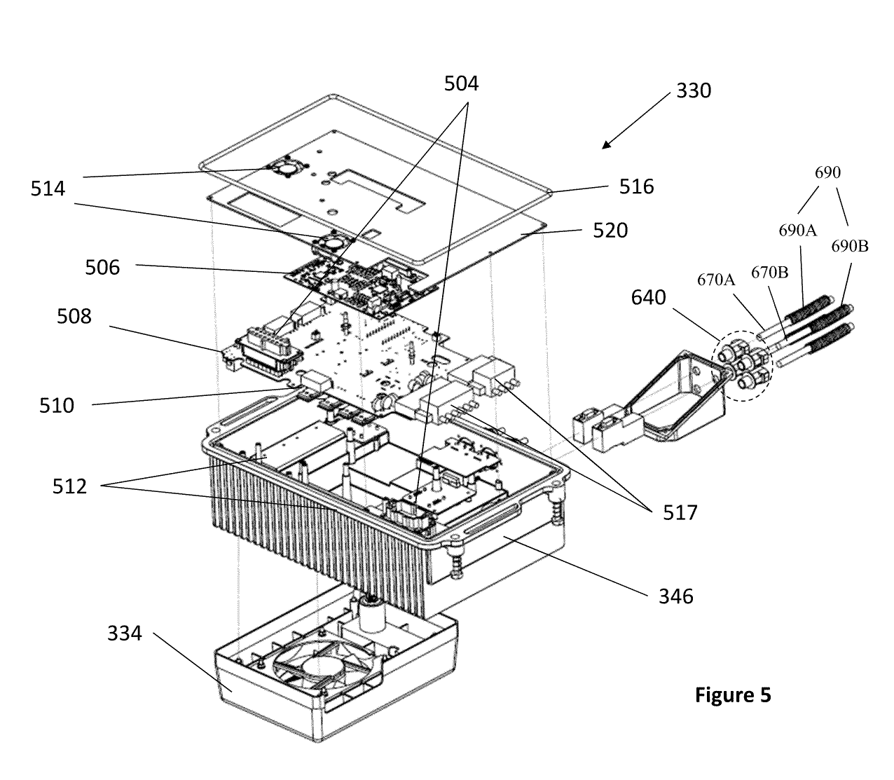

Similar to the motor drive controller 100 of FIG. 1A, the motor drive controller 300 has a sensor and a processor. The sensor and the processor are provided on a central control processor board 506 (see FIG. 5). The sensor, which may be a communication sensor, is configured to detect a status of a network controller (not shown in FIG. 3, but see reference numeral 204 in FIGS. 2A and 2B) controlling operation of a network of motor drive controllers (not shown in FIG. 3, but see reference numeral 202 in FIGS. 2A and 2B). The processor is configured to enter into a slave operation mode, in which the processor receives operating instructions from the network controller; or a master operation mode, in which the processor provides operating instructions to the network of motor drive controllers. The processor is further configured to receive the status of the network controller from the sensor and select the master operation mode when the network controller is inactive.

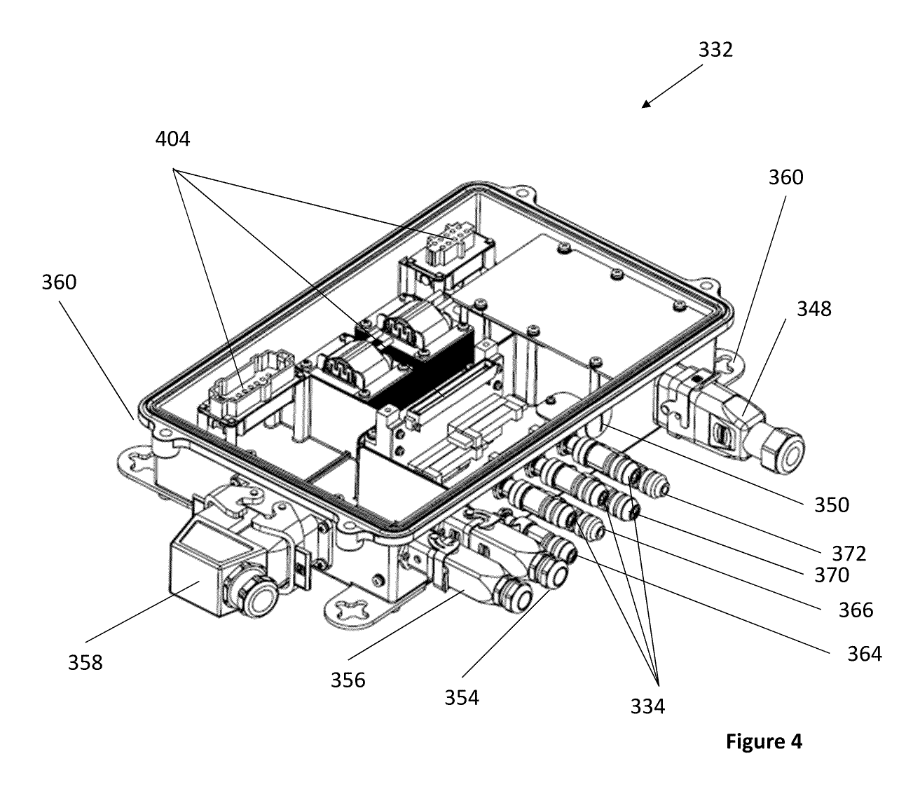

The motor drive controller 300 is designed to be a modular unit, whereby its housing has a top unit where electronic components of the motor drive controller 300 are located and a bottom unit, where wirings that couple to the electronic components are located. With reference to FIG. 4, which shows a perspective view of the bottom unit, these wirings are not shown for the purpose of simplicity.

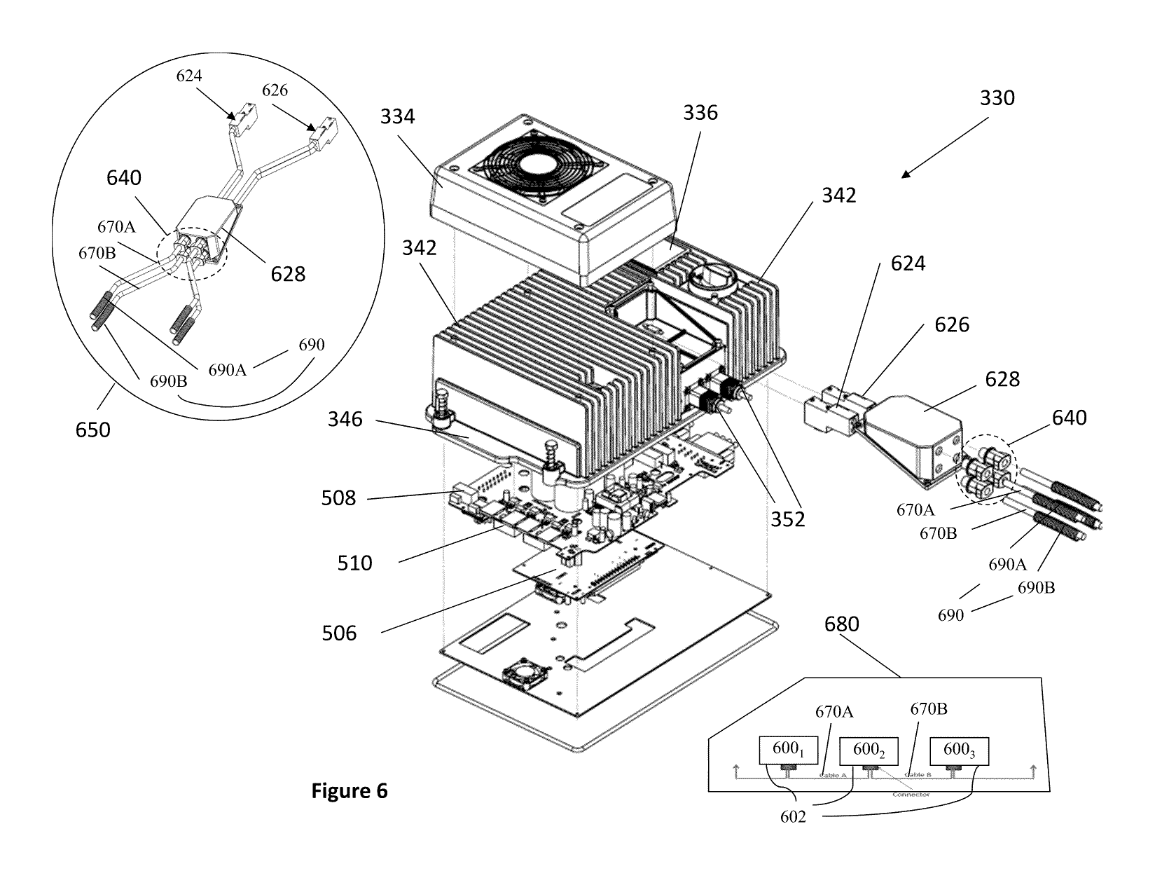

Accordingly, the motor drive controller 300 has a housing having an upper portion 330 within which the sensor and the processor are disposed. The upper portion 330 also has network or fieldbus connection/controller ports 368, 340 and 352 for connecting the motor drive controller 300 to other motor drive controllers [which in the case of FIGS. 2A and 2B is any one of the connected motor drive controllers (202₁, 202₂, . . . , 202ₙ; 202′₁, 202′₂, . . . , 202′ₙ; and 202″₁, 202″₂, . . . , 202″ₙ)]. Further detail on the connection ports 368 and 340 is provided below in the description for FIG. 6. A lower portion 332 has digital input ports 334, a digital input/output port 370, a relay output port 366, a network or fieldbus connection port 372 and an encoder input port 364. Network controller ports (352, 372 and 340) to which the sensor (i.e. the communication sensor) for detecting a status of a network controller (see reference numeral 204 of FIGS. 2A and 2B) is coupled are provided on both the upper portion 330 and the lower portion 332. The network controller ports 352 are dedicated to process data from one or more protocols: Ethernet/IP, EtherCAT and ProfiNet. The network controller port 372 is dedicated to process data by ASi communication and the network controller port 340 is dedicated to process data by Profibus communication. With reference to FIGS. 2A and 2B, the connection ports 368 for CANbus communication facilitate operation under the secondary network, while the network controller ports 352, 372 and 340 facilitate operation under the main network.

The digital input ports 334 are three digital input ports available on the motor drive controller 300. The digital input ports 334 are photo electric sensors and U sensors. The digital input ports 334 allow coupling thereto of digital sensors operable using the internal 24 VDC power supply (not shown) of the motor drive controller 300. The encoder input port 364 serves as an encoder port, which is used to receive an input signal from an encoder of a motor, such as a servo motor, connected to the motor drive controller 300. The digital input/output port 370 is provided for general use, such as for connection connecting devices such as a tower lamp, a buzzer, etc. The Profibus connection port 340 and the CANbus connection ports 368 are each provided with a respective quick conduit gland that is used to tighten conduit pipe 690 (see FIG. 6), which encloses a field bus cable that connects to each of these ports (340 and 368), and prevents dust or water from contaminating the ports (340 and 368).

The upper portion 330 is further provided with an external fan 362, a display 336, an isolator 338, quick conduit glands 640 (see FIG. 6 for clearer illustration) that cover ports 368 and 340, and a heat sink 342. The upper portion 330 secures unto the lower portion 332 by way of tightening screws 344 that are provided in a top cover handle 346 that protrudes from a side wall of the upper portion 330. The heat sink 342 is integral with and forms part of the exterior of the upper portion 330, although in other embodiments, the heat sink may be detachable from the upper portion 330.

The isolator 338 is to cut out incoming AC power supply in the event that the motor drive controller 300 has to be shut down, for instance not to interfere with other motor drive controllers. Both the heat sink 342 and the external fan 362 serve to remove heat generated during operation of the motor drive controller 300. The HMI display 336 may show information about the operation of the motor drive controller 300 and also provides an input interface to change operation parameters of the motor drive controller 300.

The lower portion 332 is further provided with externally accessible connectors such as an AC power supply input 348, an actuator sensor interface (ASI) configuration port 350, the network controller port 372 for ASi communication, a force fan connector port 354, a braking resistor connector port 356, a motor power supply port 358 and the relay output port 366 The lower portion 332 secures to the upper portion 330 by receiving the tightening screws 344 in a mounting bracket 360 that protrudes from a side wall of the lower portion 332.

The AC power supply input 348 connects to an AC power supply to power all components in the motor drive controller 300. The ASI configuration port 350 (which is adapted to receive connection with a ASI configuration device) is used to assign an identity to each of the motor drive controllers connected to the motor drive controller 300 so that a network controller (see reference numeral 204 in FIGS. 2A and 2B) can retrieve or send information to a specific motor drive controller using its assigned identity, when ASI communication is used for main network. The force fan connector port 354 provides a means to power and control a fan of a motor (not shown) that is connected to the motor drive controller 300. The braking resistor connector port 356 is for connection of a power resistor or a heat dissipation resistor, which are required in high speed applications. The relay output port 366 is provided for applications which require a relay output. The motor power supply port 358 provides power to a motor (not shown) to which the motor drive controller 300 may be connected.

Reference is now made to both FIGS. 4 and 5. FIG. 4 shows a top perspective view of the lower portion 332. FIG. 5 shows an exploded view, from the bottom, of the upper portion 330. One or more electrical connectors 504 is disposed within the upper portion 330 and one or more matching electrical connectors 404 is disposed within the lower portion 332.

The housing is designed such that each of the one or more matching electrical connectors 404 is aligned to receive a respective electrical connector 504 of the one or more electrical connectors 504 when the upper portion 330 is mounted on the lower portion 332. One or more electrical components (506, 508) disposed within the upper portion 330—including the sensor that detects a status of a network controller and the processor that determines whether a slave operation mode or a master operation mode should be selected (both the sensor and the processor being provided on a central control processor board 506)—are connected to one or more of the electrical connectors 504. Similarly, one or more electrical components disposed within the lower portion 332, are connected to one or more of the matching electrical connectors 404. These electrical connectors 404 and 504 provide a plug that allows detachment and reattachment of the one or more electrical components disposed within the upper portion 330 to the one or more electrical components disposed within the lower portion 332.

Referring to FIG. 5, the electrical components 506 and 508 are a central control processor board 506 and a high voltage power board 508.

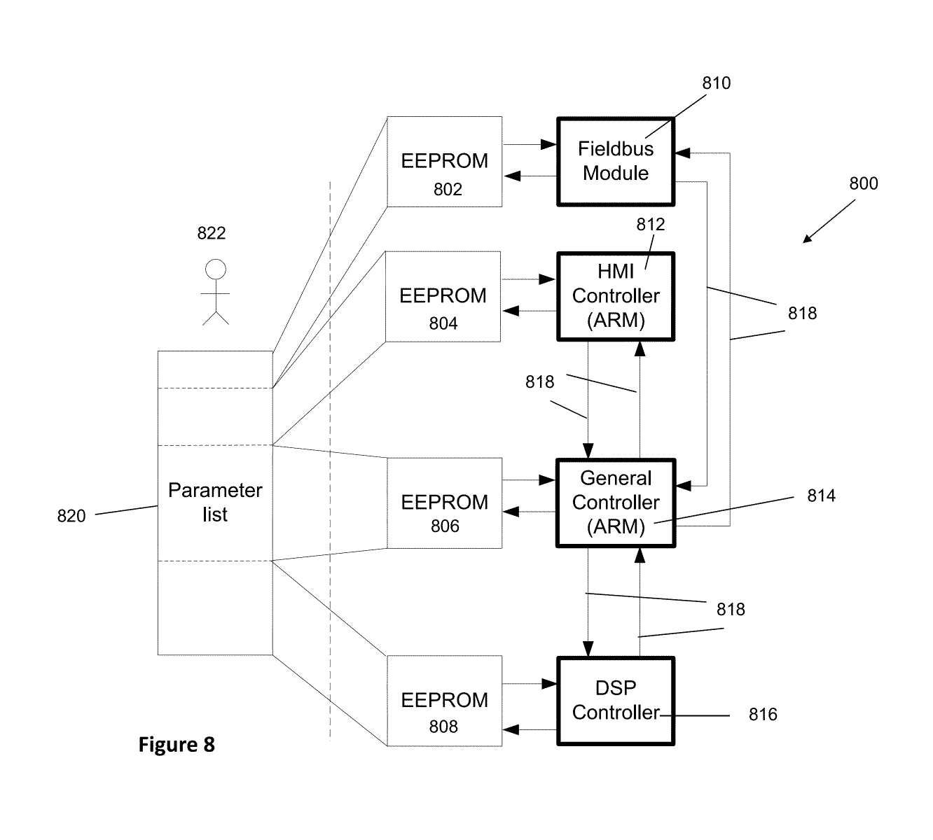

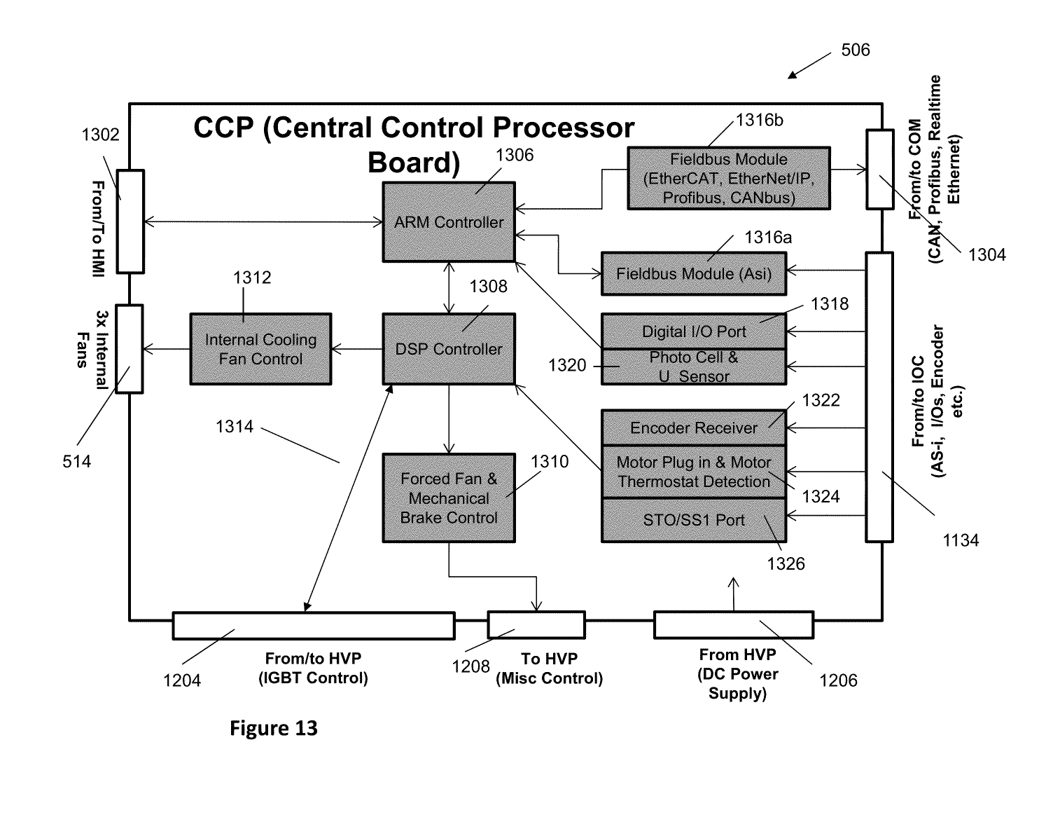

The central control processor board 506 contains electronic devices such as the processor configured with the slave operation mode and the master operation mode and the communication sensor that detects a status of a network controller to which the motor drive controller 300 is connected. The processor and the communication sensor may be integrated and implemented as a general controller (see reference numeral 814 in FIG. 8 or see reference numeral 1306 in FIG. 13). The central control processor board 506 further comprises a DSP controller (see reference numeral 816 in FIG. 8 or see reference numeral 1308 in FIG. 13) to control a motor, a fieldbus module (see reference numeral 810 in FIG. 8 or see reference numerals 1316a and 1316b in FIG. 13) to communicate with a network controller and other motor drive controllers, interface boards (1310, 1312, 1314, 1318, 1322, 1324 & 1326 in FIG. 13) and processes input from external interface devices (such as the portable device 226 shown in FIGS. 2A and 2B).

Further electrical components include a plurality of switching devices 510 (to perform the function of a switching amplifier) disposed in the upper portion 330, which in the embodiment shown in FIG. 5 is provided on the high voltage power (HVP) board 508. The HVP board 508 stabilises AC power supply output for motor operation and DC power supply output for the electronic components which require DC power such as the central control processor board 506. The HVP board 508 also includes circuits for the discrete switching devices 510 to control operation of a motor drive to which the motor drive controller 300 is connected.

Discrete amplifiers are used for the switching devices 510 because separate amplifiers are desired, rather than module amplifiers, to allow for the switching devices 510 to be distributed within the upper portion 330. This distribution allows for heat generated by the discrete switching devices 510 to be dispersed within the motor drive controller 300. In the embodiment shown in FIG. 5, insulated-gate bipolar transistors (IGBT) may be used to realise the discrete switching devices 510. In another embodiment, the switching devices may be a MOSFET or a Triac.

A thermal conductive reservoir 512 is disposed within the upper portion 330, within which the discrete switching devices 510 are immersed. In the embodiment shown in FIG. 5, a tank filled with a thermally conductive potting compound that is also non-electrical conductive is used for the thermal conductive reservoir 512. The perimeter of the central control processor board 506 is provided with a seal 516 for tightening the upper portion 330 to the lower portion 332 motor drives and for preventing contaminants such as water and dust from entering into the motor drive controller 300. One or more internal fans 514 are disposed within the upper portion 330. In the embodiment shown in FIG. 5, the internal fans 514 are mounted on a cover plate 520. Each of the internal fans 514 may be configured to activate when the temperature within the housing exceeds a predefined temperature, such as 40° C. The internal fans 514 and the thermal conductive reservoir 512 each further facilitate cooling of the motor drive controller 300 in operation.

Referring to FIG. 4, the alignment of the matching electrical connectors 404 is such that each is located to receive a corresponding respective electrical connector 504 when the upper portion 330 is mounted onto the lower portion 332. Each of the matching electrical connectors 404 will have a shape that facilitates docking with a corresponding respective electrical connector 504, e.g. if the electrical connector 504 is a male connector, the matching electrical connector 404 will be a female connector. It is through the matching electrical connectors 404 and the electrical connectors 504 that electrical signal paths from any one of the electrical components of the lower portion 332 [such as the AC power supply input 348, the actuator sensor interface (ASI) configuration port 350, the ASI connector port 372, the force fan connector port 354, the braking resistor connector port 356, the motor power supply port 358 and the relay output port 366] is established with the electrical components of the upper portion 330 (such as the central control processor board 506 and the high voltage power board 508).

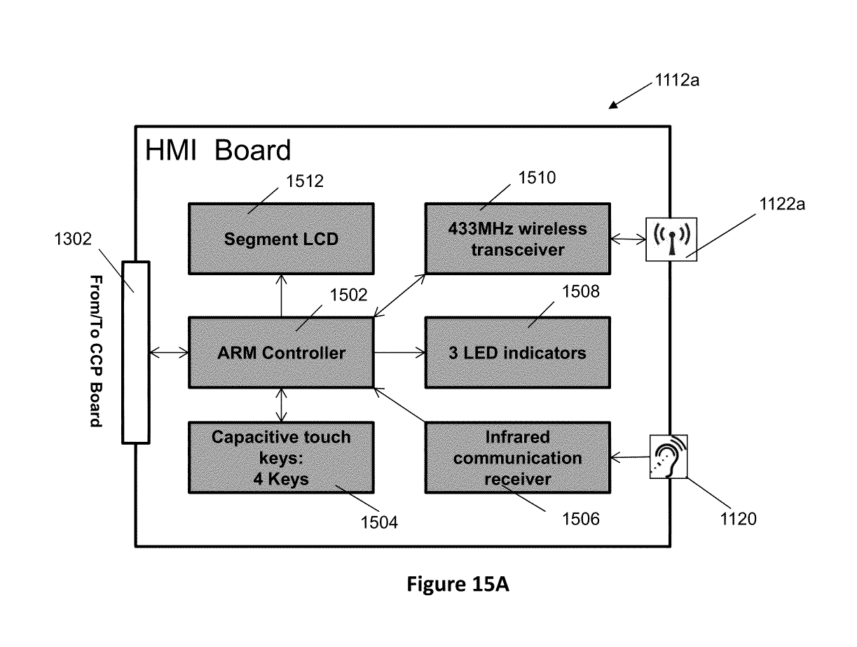

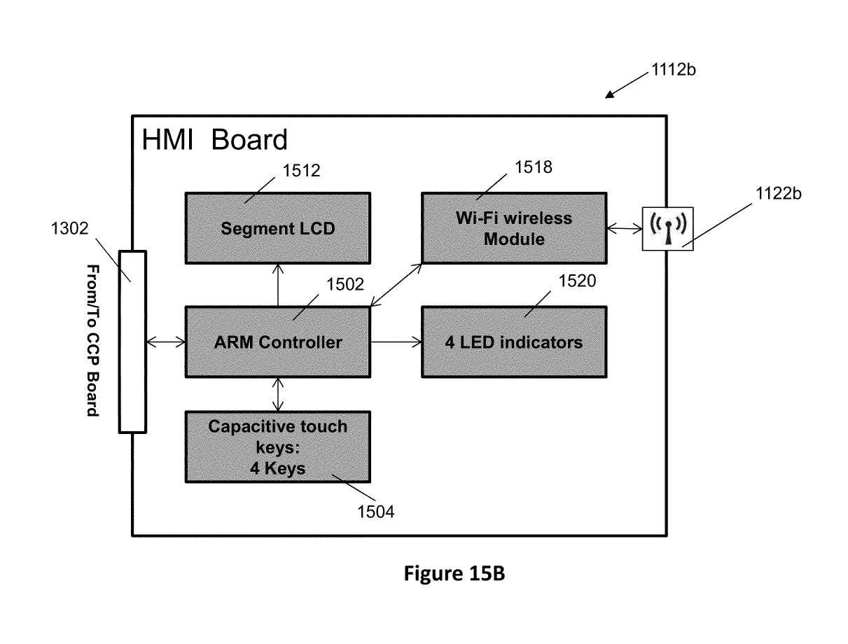

FIG. 6 shows an exploded view, from the top, of the upper portion 330. The upper portion 330 further comprises an infrared port, from which the processor (provided in the central control processor board 506) is configured to receive operation parameters. In the embodiment shown in FIG. 6, the infrared port may be provided at the display 336. A wireless transceiver may also be provided in the upper portion 330 (such as in HMI boards 1112a and 1112b shown respectively in FIGS. 15A and 15B), through which the processor is configured to provide and receive operation parameters to an external interface device (such as the portable device 226 shown in FIGS. 2A and 2B) that is used to monitor operation of the motor drive controller 300.

FIG. 6 also shows that an exterior of the upper portion 330 is provided with a heat sink 342. The discrete switching devices 510 may be arranged to have their generated heat dissipated by the heat sink 342 by being placed in proximity to an interior of the upper portion 330 corresponding to where the heat sink 342 is provided on the exterior of the upper portion 330. In one embodiment, the surface of the discrete switching devices 510 may even contact the interior wall of the upper portion 330. The dissipation of heat is further facilitated by providing the heat sink 342 with the exterior fan 334. The exterior fan 334 may be detachable from the heat sink 342 and may not be needed for an embodiment of the motor drive controller 300 that has a power rating that is below 4 kW.

The ports (which include connection ports 368 and 340, see FIG. 3) covered by the quick conduit glands 640 are for conduit pipes 690, with each conduit pipe 690A and 690B enclosing a field bus cable of Dsub connector configuration. These ports, provided by fieldbus plugs 624 and 626, are designed to be detachable from the upper portion 330 while maintaining operation of the network of motor drive controllers from which the motor drive controller 300 is disconnected. Connectivity of the remaining motor drive controllers is facilitated by a bypass circuit within these fieldbus plugs 624 and 626, which is configured to activate when the fieldbus plugs 624 and 626 are detached.

Referring to insets 650 and 680, when a mechanical system (not shown) connected to a motor drive controller 600₂ is to be removed from a network 602, the mechanical system is removed together with the motor drive controller 600₂. The fieldbus plugs 624 and 626, transparent cover 628 and the quick conduit glands 640 will remain in the network 602 together with communication cables 670A and 670B used to connect motor drive controllers 600₁ and 600₃ to 600₂, so that the communication to motor drive controllers 600₁ and 600₃ will remain uninterrupted. Thus, both the motor drive controller 600₂ and the mechanical system can be removed without disruption to the remaining network of motor drive controllers and the zone of mechanical systems to which the remaining network of motor drive controllers is connected remains in operation. In the embodiment shown in FIG. 6, the network controller ports 352 are configured to receive RJ45 cables.

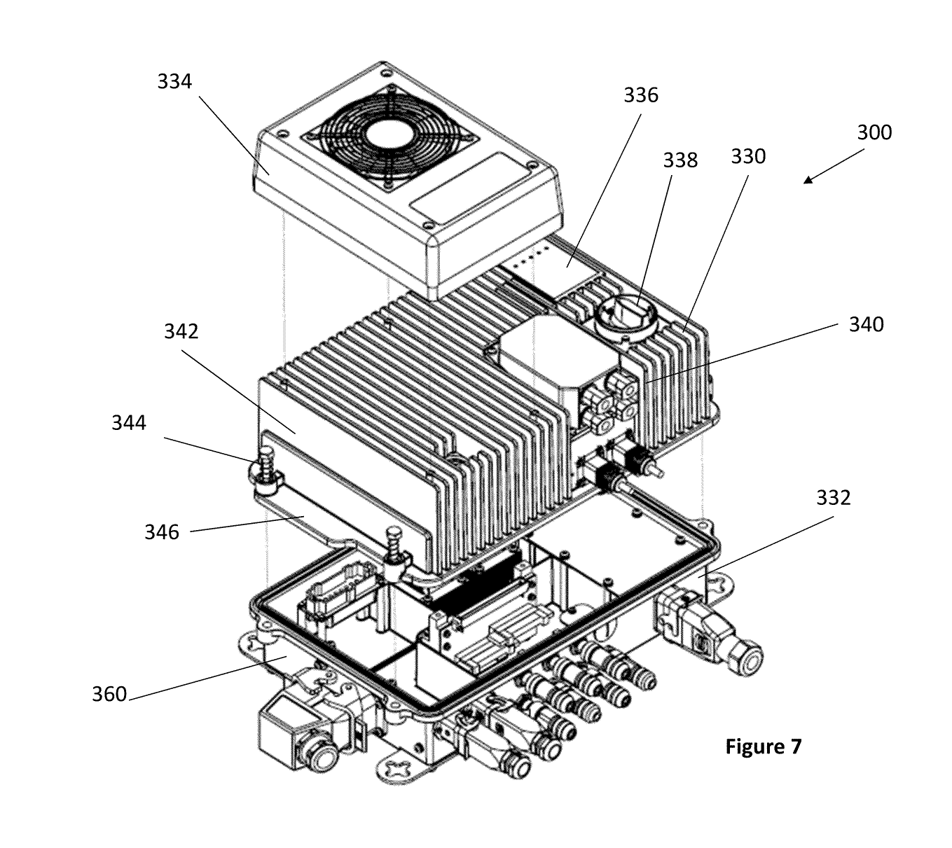

FIG. 7 shows an exploded view of the motor drive controller 300. From the above description, it will be appreciated that if the electronic components within the upper portion 330 break down, replacement of the upper unit 330 may only require three simple steps. First, the tightening screws 344 are removed from the mounting bracket 360 of the lower portion 332. Second, the upper portion 330 is unplugged and removed, whereby the top cover handle 346 provides a handle that facilitates this removal. Third, a new upper portion 330 is mounted onto the lower portion 332. The swapping of a new upper portion 330 is easy and fast.

FIG. 8 shows a schematic 800 of control parameter management that is employed by the motor drive controller 300 of FIGS. 3 to 7.

The motor drive controller 300 may include one or more memory modules (802, 804, 806 and 808), wherein each of the memory modules (802, 804, 806 and 808) is configured to store unique parameters associated with an assigned function. These unique parameters are part of a parameter operation list 820 which is accessible by a user 822 through, for example, a portable monitoring device (not shown in FIG. 8, but refer to portable devices 226a and 226b) and a control panel (such as the display 336 shown in FIG. 3).

Each of these memory modules (802, 804, 806 and 808) are separate units, so that the respective controllers (810, 812, 814 and 816) to which the memory modules (802, 804, 806 and 808) are connected do not share any memory. Under the control parameter management system shown in FIG. 8, the parameters in the parameter operation list 820 are distributed across the four memory modules (802, 804, 806 and 808), so that each memory module (802, 804, 806 and 808) has unique parameters. The unique parameters also provide the controller (810, 812, 814 and 816) to which the respective memory module (802, 804, 806 and 808) is connected with the function associated with the unique parameters, so that the controllers (810, 812, 814 and 816) manage the parameters to which each has access. This eliminates having to duplicate parameter copies and in turn eliminates the need to ensure that data consistency, which is required if a common memory (as opposed to separate memory modules) is used. If there is a need for any of the controllers (810, 812, 814 and 816) to access the operation parameters of another one or more of the controllers (810, 812, 814 and 816), these operation parameters will be communicated through UART serial interface 818 that is used to connect one of the controllers (810, 812, 814 and 816) to another one or more of the controllers (810, 812, 814 and 816).

In the preferred embodiment, the memory modules 810, 814 and 816 are located on the central control processor board 506 (see FIGS. 5 and 6), while the memory module 812 is located on a HMI board 1112a or 1112b (see FIGS. 15A and 15B respectively, where the memory module 812 is integrated into a controller processor 1502). In another embodiment, the memory modules (802, 804, 806 and 808) and the controllers (810, 812, 814 and 816) may be located on the central control processor board 506 (see FIGS. 5 and 6). An EEPROM may be used for each of the memory modules (802, 804, 806 and 808).

The one or more memory modules (802, 804, 806 and 808) include: a first memory module 806 configured to store operating parameters for a general controller 814 (which in one embodiment is a main controller that provides instructions to the processor that selects whether the motor drive controller 300 is in the master operation mode or the slave operation mode); a second memory module 808 configured to store operating parameters for a DSP controller 816; a third memory module 804 configured to store operating parameters for an HMI controller 812; and a fourth memory module 802 configured to store operating parameters for fieldbus modules 810. The fieldbus modules 810 include instructions that are compatible with bus protocols such as ASibus, CANbus, Profibus; and Ethernet protocols such as Profinet, EtherCAT and Ethernet UP. The general controller 814 may be a 32-bit RISC (reduced instruction set computer) microprocessor using Advanced RISC Machines, Ltd. (ARM) architecture.

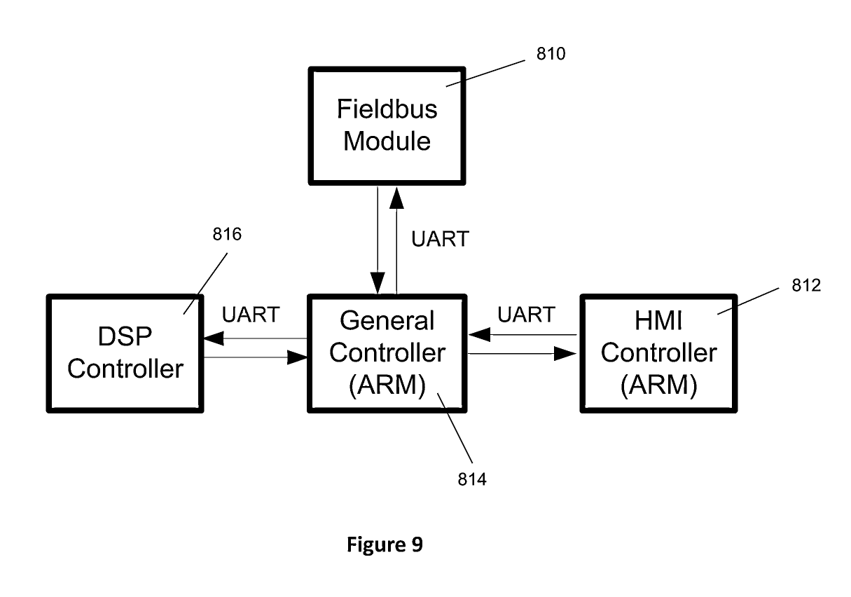

FIG. 9 shows a schematic illustrating data exchange between the controllers (810, 812, 814 and 816) shown in FIG. 8. A low data payload is exchanged between the controllers (810, 812, 814 and 816). Data exchange between the general controller 814 and the other three controllers 810, 812 and 816 falls under either a cyclic data exchange or an acyclic data exchange classification.

Under cyclic data exchange, one controller sends a telegram containing a control word to another controller, which has to respond as fast as possible with a telegram containing a status word. Different controllers have different control word and status word. For instance, between the general controller 814 and the DSP controller 816; the general controller 814 and the HMI controller 812; the general controller 814 and the fieldbus module 810, these words may respectively be Motor Controller Control Word, Motor Controller Status Word; HMI Control Word, HMI Status Word; and Field bus Control Word, Field bus Status Word. Such cyclic data exchange may be conducted at a predefined frequency or predefined time interval; normally set at 10 ms. In every 10 ms there will be a cyclic communication telegram exchange between two controllers. This telegram can also be called a heart-beat telegram.

Referring to FIG. 9; there are 3 pairs of communication. For the communication pair between the field bus module 810 and the general controller 814, the field bus module 810 sends a control word to the general controller 814 and the general controller 814 responds with a status word. Thus, the field bus module 810 acts as a master while the general controller 814 acts as a slave. For the other two pairs of communication, the general controller 814 is a master, while the DSP controller 810 and the HMI controller 812 are slaves.

The benefits of cyclic data exchange include:
Real time. The control word and status word are updated every heart-beat;
Deterministic. The communication is expected or predictable.
Diagnostic. If no heart beat telegram is received for a certain time interval, then a transmitting controller realises that the receiving controller is down or communication is lost.

Under acyclic data exchange, one controller sends a telegram to another controller at any time, which may or may not reply to the telegram and does not have to be reply quickly. There is no master or slave. Any controller can initiate a data exchange. Acyclic data exchange can occur at any time, for instance, during an interval of cyclic data exchange. The cyclic data exchange can be stopped by a special telegram.

The phase with cyclic data exchange is the on-line state, while the phase without cyclic data exchange is the off-line stage. On-line state contains both cyclic and acyclic data exchange while the off-line state contains only acyclic data exchange.

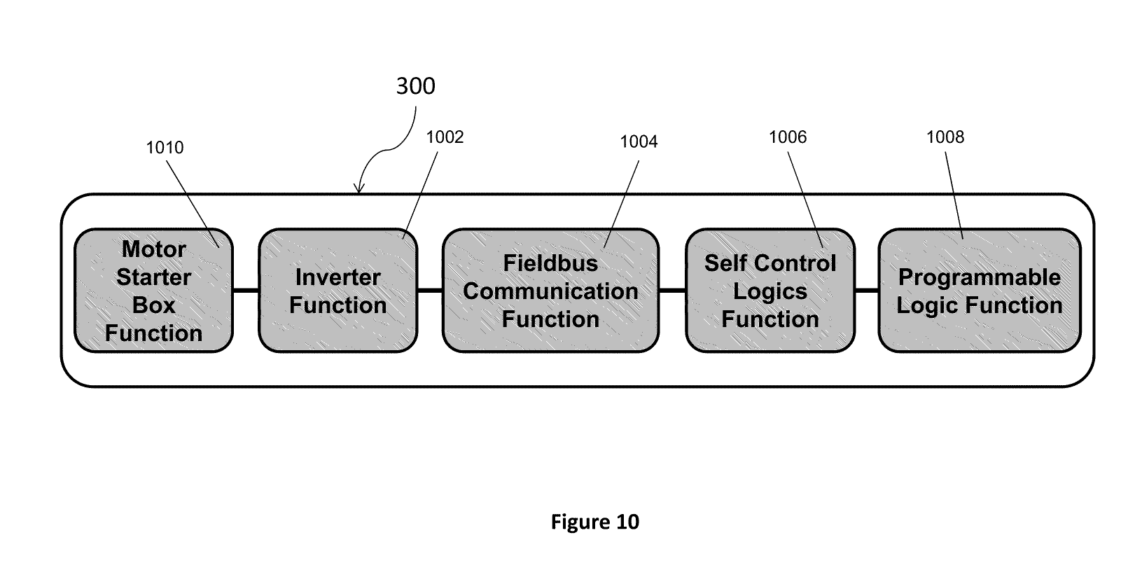

FIG. 10 shows a schematic of the motor drive controller 300 of FIGS. 3 to 7 and the various functions provided by the motor drive controller 300.

The various functions include an inverter function 1002, fieldbus communication function 1004, self control logic function 1006, programmable logic controller function 1008 and motor starter box function 1010.

The motor starter box function 1010 provides the motor drive controller 300 with I/O (input/output) interfaces for sensors and encoders, such as those provided by a conventional motor starter box.

The inverter function 1006 allows the motor drive controller 300 to be configured with different control profiles that can, for example, change the speed of a motor to which the motor drive controller 300 is connected.

The field-bus communication function 1004 provides the motor drive controller 300 with several standard fieldbus communication protocols (such as Asi bus, Ethernet/IP, EtherCAT, ProfiBus and ProfiNet under main network operation; and CANbus under secondary network operation) which allows the motor drive controller 300 to communicate with available PLC (programmable logic controller) units.

The self control logic function 1006 provides the motor drive controller 300 with pre-programmed critical control logic available for use in mechanical systems such as baggage handling systems, automation systems, process control system, etc. However, if the mechanical systems in which the motor drive controller 300 is to be used implements application logic that is different from the pre-programmed control logic, the programmable logic controller function 1008 will allow a user to write their own application logic. The programmable logic controller function 1008 provides the motor drive controller 300 with a programming platform, such as CoDeSys (Controller Development System) which allows five kinds of common programming languages, such as IL (Instruction list); ST (Structured text); LD (Ladder diagram); FBD (Function block diagram); and SFC (Sequential function chart).

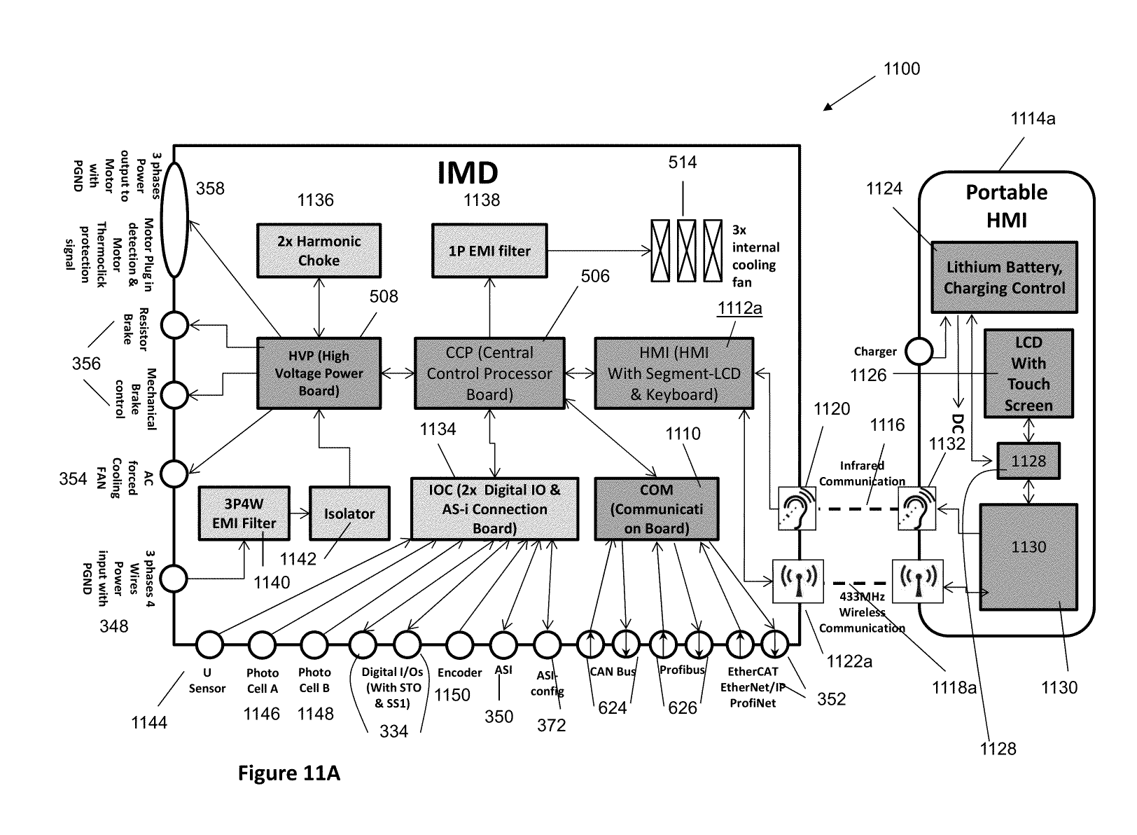

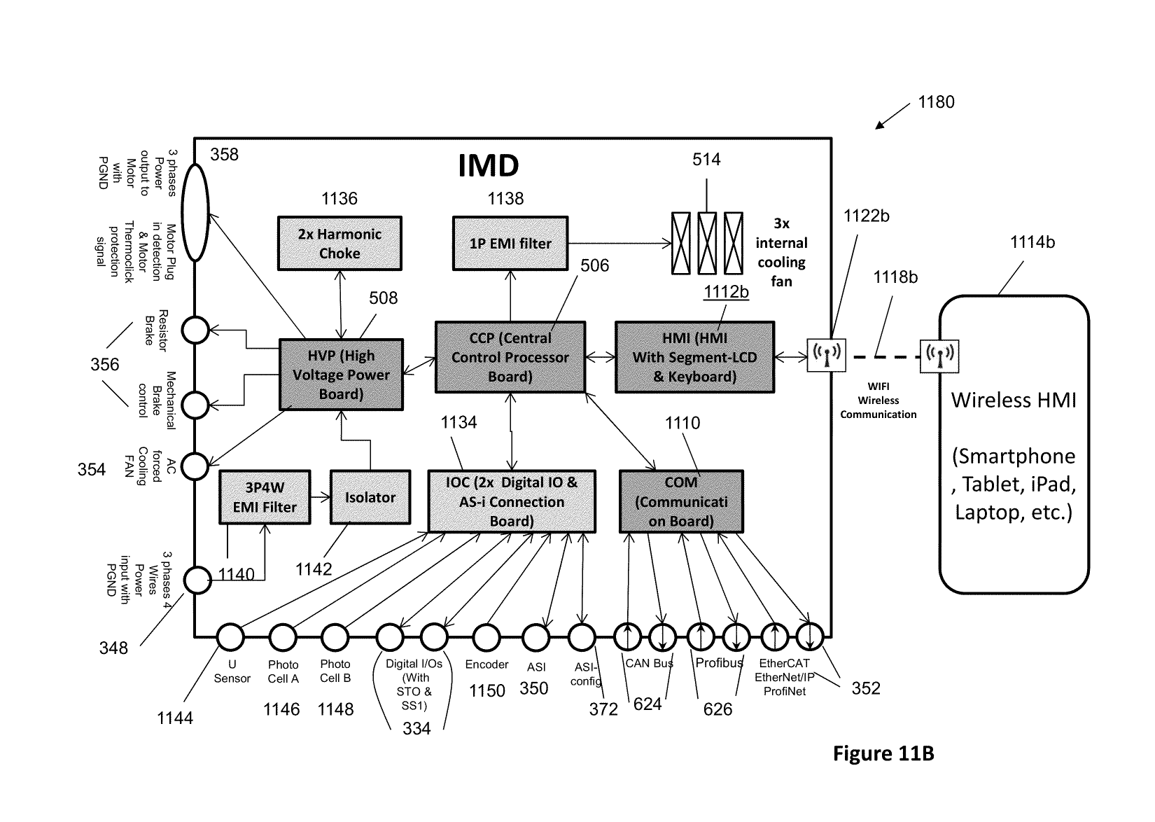

FIG. 11A shows a layout 1100 of the hardware of the motor drive controller 300 of FIGS. 3 to 7. Arrows denote the manner in which signals flow between any two pieces of hardware and also denote that these two pieces of hardware are coupled together.

The hardware includes a high voltage power (HVP) board 508 (also see FIG. 5), the central control processor (CCP) board 506 (also see FIGS. 5 and 6), a communication (COM) board 1110, an input-output connection (IOC) board 1134 and a human machine interface (HMI) board 1112a.

The units 508, 1108, and 1112a have processing capability. The IOC board 1134 and the COM board 1110 are connection boards that allow data signals to pass through. The remaining hardware: a harmonic choke 1136; an electromagnetic (EMI) filter 1138 that connects the CCP board 1108 to internal cooling fans 514 (also see FIG. 5); a 3 phase 4 wire (3P4W) filter 1140 connected to the HVP board 508 through an isolator 1142 are passive components.

Other hardware such as the motor power supply port 358 (also see FIG. 3), which provides grounded 3 phase power output to a motor and has motor plug in detection and a motor protection signal; the braking resistor connector port 356 (also see FIG. 3), which provides resistor brake and mechanical brake control; the force fan connector port 354 (also see FIG. 3); the AC power supply input 348; a U sensor 1144; photo cell ports 1146 and 1148 (also see digital input ports 334 in FIG. 3); an encoder 1150; the ASI configuration port 350 (also see FIG. 3), the ASI connector port 372 (also see FIG. 3); the fieldbus plugs 624 and 626 (also see FIG. 6) are externally accessible ports. The U sensor 1144 and the photo cell ports 1146 and 1148 are connecting ports for digital inputs from sensors.

The HMI board 1112a is designed and configured to be able to communicate with a portable HMI 1114a via an infrared signal 1116 received by an infrared port 1120 provided at an exterior of the motor drive controller 300, or via a wireless signal 1118a transmitted by a wireless transceiver 1122a. The portable HMI 1114a may be a handheld device comprising a battery source 1124, a display 1126, a processor 1128 and an infrared and wireless communication transceiver 1118a.

In infrared communication mode (i.e. through the use of infrared signals 1116), the motor drive controller 300 can receive operation parameter data from the processor 1128 of the portable HMI 1114a. This allows the portable HMI 1114a to sync operation parameter data of selected motor drive controllers 300 by proximity handshake requiring a line of sight between the infrared port 1120 of the motor drive controller 300 and an infrared port 1132 of the portable HMI 1114a. After this handshake, the motor drive controller 300 can be accessed through wireless communication 1118a. Wireless communication mode (i.e. through the use of wireless signals 1118a) allows the portable HMI 1114a to access operation parameter data of motor drive controllers 300 that are within the wireless range of the portable HMI 1114a, without requiring a line-of-sight between the portable HMI 1114a and these motor drive controllers 300. Wireless communication mode is flexible in location as an operator can access the data of individual motor drive controllers 300 over a wide distance. The HMI board 1112a allows ease of monitoring and modifying operation parameters of motor drive controllers 300 as the portable HMI 1114a is a portable handheld device.

FIG. 11B shows a layout 1180 of the hardware of the motor drive controller 300 of FIGS. 3 to 7. The difference between the motor controllers 300 represented in FIGS. 11A and 11B is that the one in FIG. 11B is communicating with a different HMI device 1114b. In FIG. 11B, the HMI device 1114b may not be a portable device that is specifically designed to communicate with the motor drive controller 300, but may be a generic device such as a smartphone, a tablet PC or a laptop having installed therein a software application designed to allow the HMI device 1114b to communicate with the HMI board 1112b. Communication with the HMI board 1112b may occur via a wireless signal 1118b (such as over Wi-Fi) received by a wireless transceiver 1122b, with the signals processed by the HMI board 1112b.

In both FIGS. 11A and 11B, each of the HMI devices 1114a and 1114b act as an operator interface between an operator and the central control processor board 506 and provides a communication path between the central control processor board 506 and other HMI devices 1114a and 1114b. The HMI devices 1114a and 1114b, being external devices, provide convenient access to the motor drive controller 300 over a wide distance. By using the HMI devices 1114a and 1114b, or the input interface provided at the display 336 (see FIG. 3), an operator can access the motor drive controller 300 to perform tasks such as: 1) configuring parameters; 2) sending motor control commands such as start, stop, forward run, reverse run etc.; and 3) getting the status of motor drive controller 300 such as value of current, voltage, power factor, active power, etc.

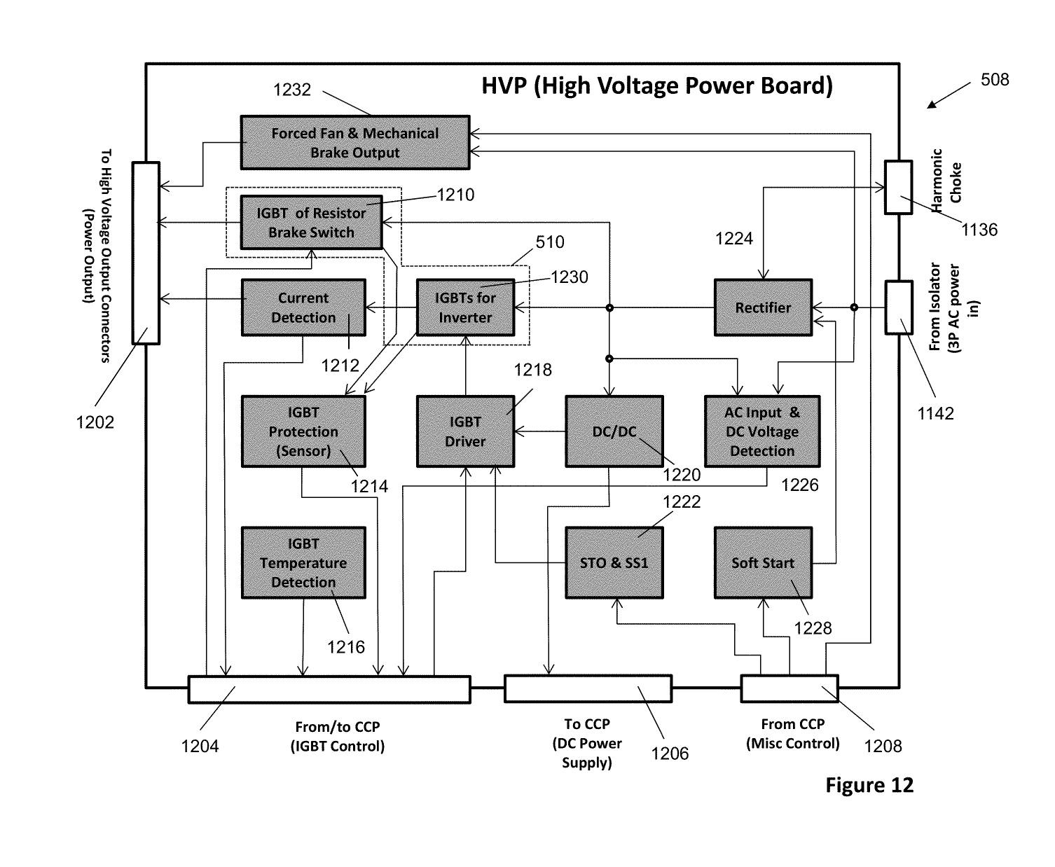

FIG. 12 shows the architecture of the HVP board 508 of FIGS. 11A and 11B. Arrows denote the manner in which signals flow between any two components and also denote that these two components are coupled together.

The main function of the HVP board 508 is to transform three phase incoming power supply to stabilized AC Power Supply output for motor operation and DC power supply output for the circuits which require DC power such as the CCP board 1108 of FIGS. 11A and 11B. It also provides controls for motor operation and circuitry (namely an IGBT driver unit 1218) for switching devices 510.

The HVP board 508 comprises the following components: a forced fan and mechanical brake output unit 1232; a current detection unit 1212; an IGBT protection sensor 1214; an IGBT temperature detector 1216; an IGBT driver 1218; switching devices 510 (also see FIG. 5) including IGBTs 1230 for inverters and an IGBT 1210 for a resistor brake switch unit; a DC/DC unit 1220; a STO (Safe Torque Off) and SS1 (Safe Stop Category-1) unit 1222; a rectifier unit 1224 which is coupled to the isolator 1142 of FIGS. 11A and 11B and the harmonic choke 1136 of FIGS. 11A and 11B, an AC input and DC voltage detection unit 1226; and a soft start 1228 unit.

The DC/DC unit 1220 is a circuit which changes a DC voltage output provided to devices connected to the motor drive controller 300, as different devices operate at different DC voltage levels. The STO and SS1 unit 1222 unit is a safety function integrated to the motor drive controller 300 for cutting power to a motor drive when there is an emergency. The soft start 1228 unit is a circuit that facilitates smooth starting of a motor drive by preventing peak current, peak load and high mechanical stress to occur when the motor drive starts.

Reference numerals 1208, 1206 and 1204 denote interfaces the HVP board 508 has with the CCP board 1108 of FIGS. 11A and 11B. Miscellaneous controls are received from the CCP board 1108 via the interface 1208, DC power is supplied to the CCP board 1108 via the interface 1206, while IGBT control signals are both received from and sent to the CCP board 1108. Reference numeral 1202 is used to denote an interface with the motor power supply port 358, the braking resistor connector port 356 and the force fan connector port 354.

FIG. 13 shows the architecture of the CCP board 506 of FIGS. 11A and 11B. Arrows denote the manner in which signals flow between any two components and also denote that these two components are coupled together. The CCP board 506 is mainly for providing motor control to DSP controller 1308, field-bus control to fieldbus modules 1316a & 1316b and HMI control to the HMI controller 1502 of FIGS. 15A and 15B.

The CCP board 506 comprises the following components: an ARM controller 1306, a DSP (digital signal processor) controller 1308; a forced fan and mechanical brake control signal 1310; an internal cooling fan control 1312 which is coupled to the internal fans 514 of FIGS. 11A and 11B; fieldbus modules 1316a & 1316b for all fieldbus communication; a digital I/O port 1318 for digital inputs and digital output connections 1318; a photo cell and U sensor connections 1320 for both the U sensor 1144 and photo cell ports 1146 and 1148 of FIGS. 11A and 11B; an encoder receiver connection 1322 for the encoder port 1150 of FIGS. 11A and 11B; a motor plug-in and motor thermostat detection connection 1324 for the motor power supply port 358 of FIGS. 11A and 11B; and a STO/SS1 connection 1326 for the STO and SS1 unit 1222 of FIG. 12.

The CCP board 506 couples with the HVP board 508 of FIG. 12 via the interfaces 1204, 1206 and 1208 as described earlier with reference to FIG. 12. Control signals 1314 that provide information on the status of the IGBT protection sensor 1214, the IGBT temperature detector 1216 and the IGBT driver 1218 of FIG. 12 are communicated to the DSP controller 1308 by the interface 1204. Reference numeral 1302 denotes an interface between the CCP board 506 and the HMI board 1112a, 1112b of FIGS. 11A and 11B respectively, through which commands are sent between the ARM controller 1306 and the HMI controller 1502 in the HMI board 1112a, 1112b of FIGS. 15A and 15B respectively. Reference numeral 1304 denotes an interface between the CCP board 506 and the COM board 1110 of FIGS. 11A and 11B, through which commands are sent between the ARM controller 1306 and the COM board 1110. The components 1316, 1318, 1320, 1322, 1324 and 1326 are also coupled to the IOC unit 1134 of FIGS. 11A and 11B.

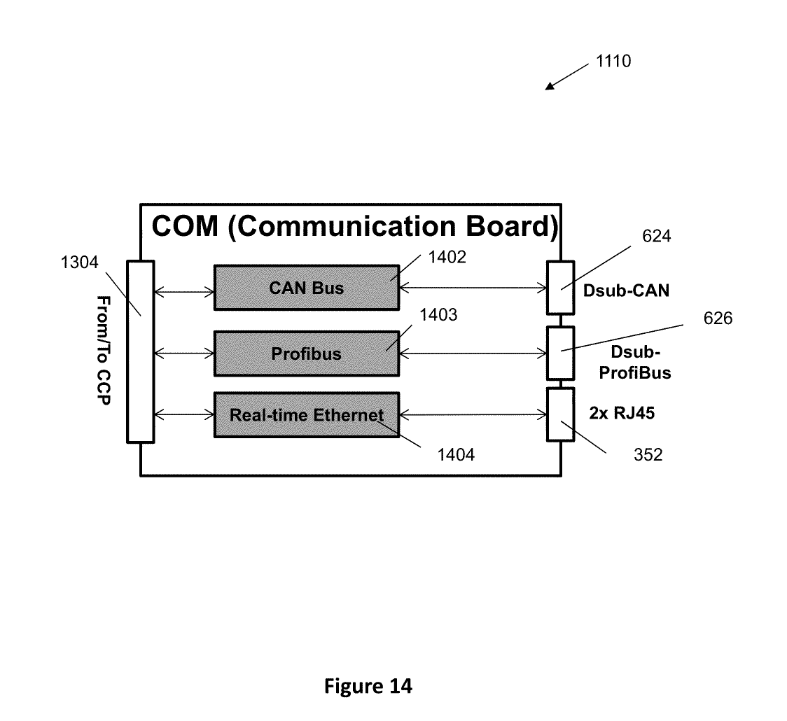

FIG. 14 shows the architecture of the COM board 1110 of FIGS. 11A and 11B. Arrows denote the manner in which signals flow between any two components and also denote that these two components are coupled together.

The COM board 1110 comprises the following components: a CAN bus connection 1402 for the CAN bus connectors 624 of FIGS. 11A and 11B; a Profibus connection 1403 for the Profibus connector 626 of FIGS. 11A and 11B; and an Ethernet connection 1404 for the RJ45 ports 352 of FIG. 6, which can be for Ethernet/IP, EtherCAT and Profinet communication. The COM board 1110 couples with the CCP board 1108 of FIG. 13 via the interface 1304, as described earlier with reference to FIG. 13.

FIG. 15A shows the architecture of the HMI board 1112a of FIG. 11A. Arrows denote the manner in which signals flow between any two components and also denote that these two components are coupled together.

The HMI board 1112a comprises the following components: an ARM controller 1502 for controlling a LCD display 1512; a wireless transceiver unit 1510 that is coupled to the wireless transceiver 1122a; LED indicators 1508; an infrared communication receiver 1506 for the infrared port 1120; and a capacitive touch key controller 1504. The HMI board 1112 couples with the CCP board 1108 of FIG. 13 via the interface 1302, as described earlier with reference to FIG. 13.

In another preferred embodiment, the infrared communication receiver 1506 facilitates infrared communication that provides a hand shake signal to initiate communication between an external remote control unit such as the portable HMI 1114a shown respectively in FIG. 11A. After the hand shake signal, the wireless transceiver unit 1510 allows wireless communication to access the motor drive controller 300 for any one or more of the following tasks: i) configuring Data such as setting parameters; ii) sending motor control commands such as start, stop, forward run, reverse run, etc; and iii) obtaining a present status of the motor drive controller 300 such as value of current, value of voltage, etc.

FIG. 15B shows the architecture of the HMI board 1112b of FIG. 11B. The architecture shown in FIG. 15B is the same as that of FIG. 15A, except that the HMI board 1112b does not have an infrared communication receiver and an infrared port. In addition, a wireless module 1518 that is suitable for receiving Wi-Fi protocol (instead of 433 MHz protocol) is coupled to the wireless transceiver 1122b. Furthermore, 4 LED indicators 1508 may be used instead of 3 LED indicators.

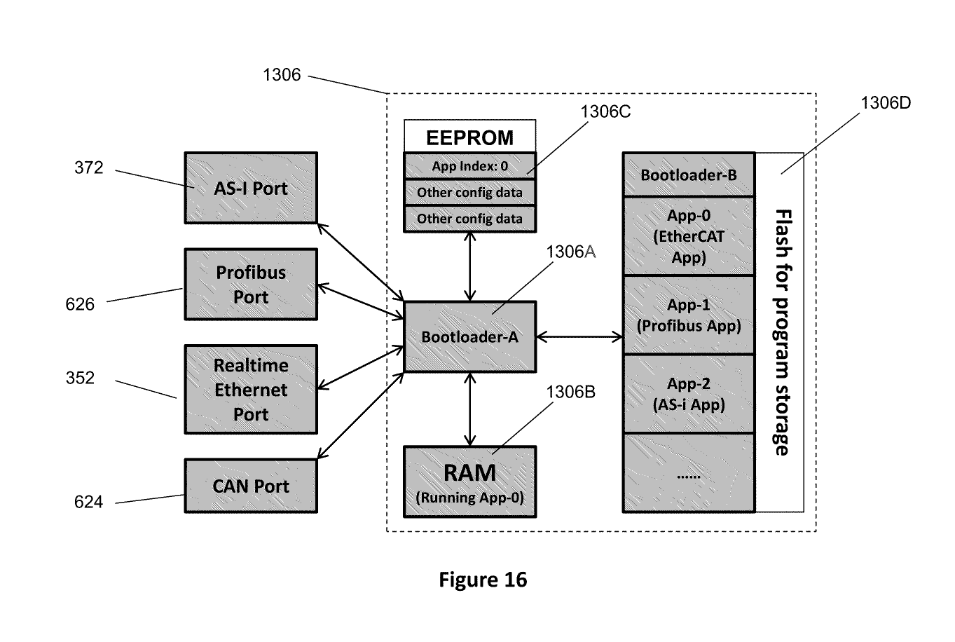

FIG. 16 shows an architecture of the ARM controller 1306 of the CCP board 506 shown in FIG. 13.

The motor drive controller 300 supports external hardware ports such as the network controller port 372 for ASi communication, the fieldbus plugs 624 and 626 providing a CAN port and a profibus port respectively and the network controller port 352 for Ethernet communication. The communication protocol that these ports (372, 626, 352 and 624) use is configurable either using the HMI devices 1114a and 1114b (see FIGS. 11A and 11B) or the input interface provided at the display 336 (see FIG. 3).

The ARM controller 1306 performs two tasks when configuring the communication protocol for fieldbus selection. The first task enables the connected physical port and the second task enables a selected fieldbus communication by the steps stated below.

After a connector is connected to one of the ports (350, 626, 352 and 624), the related software application module to process signals from the connector can be configured through the HMI devices 1114a and 1114b (see FIGS. 11A and 11B) or the input interface provided at the display 336 (see FIG. 3). Consider the example where an RJ45 cable is connected to the network controller port 352 and EtherCAT communication is selected for the main network,

Flash memory 1306D of the ARM controller 1306 stores different software application modules for different fieldbus communication. For example, App-0 is the application module for EtherCAT, App-1 is for Profibus and App-2 is for ASI bus.

App Index:0 in EEPROM memory 1306C is for the software application modules in App-0 of the flash memory 1306D. Although not shown, there is an App Index-1 for App-1 of the flash memory 1306D and App Index-2 for App-2 of the flash memory 1306D. In the HMI devices 1114a and 1114b (see FIGS. 11A and 11B) or the input interface provided at the display 336 (see FIG. 3), App Index-0 may be represented by a numeric character ‘0’; App Index-1 may be represented by numeric character ‘1’; and App Index-2 may be represented by numeric character ‘2’. Therefore, for EtherCAT communication, the operator selects numeric character ‘0’ through the HMI devices 1114a and 1114b (see FIGS. 11A and 11B) or the input interface provided at the display 336 (see FIG. 3), which is reflected as App Index-0 in EEPROM memory 1306C and as App-0 in the flash memory 1306D.

Once the operator configures the numeric character (for example, ‘0’) through the HMI devices 1114a and 1114b (see FIGS. 11A and 11B) or the input interface provided at the display 336 (see FIG. 3), Bootloader 1306A of the ARM controller 1306 receives a signal to write the corresponding App Index (for example, App Index-0) to the EEPROM 1306C. Subsequently, the Bootloader 1306A loads the corresponding software application module (for example, App-0) from the flash memory 1306D into RAM memory 1306B. The RAM memory 1306B provides working memory for the selected software application module. Once the software application module is loaded to the RAM memory, the selected field bus application (for example, EtherCAT) is ready to allow the motor drive controller 300 to communication with a network controller (see reference numeral 204 of FIGS. 2A and 2B) or other motor drive controllers.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A motor drive controller for use in a network of motor drive controllers, the motor drive controller comprising:
a sensor configured to detect a status of a network controller controlling operation of the network of motor drive controllers; and
a processor configured to enter into a slave operation mode, in which the processor receives operating instructions from the network controller, or a master operation mode, in which the processor provides operating instructions to the network of motor drive controllers, wherein the processor is further configured to receive the status of the network controller from the sensor and select the master operation mode when the network controller is inactive.

2. The motor drive controller of claim 1, wherein the operating instructions received from the network controller comprises an indication that the network controller retains control of the operation of the network of motor drive controllers when the network controller is active.

3. The motor drive controller of claim 1, wherein the operating instructions provided to the network of motor drive controllers comprises an indication that the motor drive controller controls the operation of the network of motor drive controllers when the network controller is inactive.

4. The motor drive controller of claim 1, wherein the processor is further configured to communicate with one or more connected motor drives for control of the one or more connected motor drives independent from the network controller.

5. The motor drive controller of claim 4, wherein the communication between the processor and the one or more connected motor drives includes the status of the one or more connected motor drives; and motor control commands comprising any one or more of the following: start, stop, forward run and reverse run, cascade start/stop, die-back, power-save, bag gap control, merge and divert.

6. The motor drive controller of claim 1, further comprising
a housing having an upper portion and a lower portion, both having one or more network controller ports to which the sensor is coupled, wherein the sensor and the processor are disposed in the upper portion and wherein the upper portion is detachable from the lower portion.

7. The motor drive controller of claim 6, wherein the housing is designed to allow at least one of the one or more network controller ports to be detachable and wherein the one or more network controller ports comprises a bypass circuit configured to activate to maintain connectivity of the network of motor drive controllers when the one or more network controller ports are detached.

8. The motor drive controller of claim 6, wherein the processor is configurable to select any one or more of the protocols Ethernet/IP, EtherCAT, ProfiBus and ProfiNet to process signals received from the one or more network controller ports.

9. The motor drive controller of claim 6, further comprising
one or more electrical connectors disposed within the upper portion; and
one or more matching electrical connectors disposed within the lower portion, wherein each of the one or more matching electrical connectors is aligned to receive a respective electrical connector of the one or more electrical connectors; wherein one or more electrical components disposed within the upper portion, including the sensor and the processor, are connected to one or more of the electrical connectors; and wherein one or more electrical components disposed within the lower portion are connected to one or more of the matching electrical connectors.

10. The motor drive controller of claim 6, wherein the upper portion further comprises an infrared port, from which the processor is configured to receive operation parameters; and a wireless transceiver to which the processor is configured to provide operation parameters.

11. The motor drive controller of claim 6, further comprising a plurality of switching devices that are disposed in the upper portion.

12. The motor drive controller of claim 11, wherein the switching devices are distributed within the upper portion.

13. The motor drive controller of claim 11, further comprising a thermal conductive reservoir disposed within the upper portion, within which the switching devices are immersed.

14. The motor drive controller of claim 6, further comprising an internal fan that is disposed within the upper portion.

15. The motor drive controller of claim 14, wherein the internal fan is configured to activate when the temperature within the housing exceeds a predefined temperature.

16. The motor drive controller of claim 6, wherein an exterior of the upper portion is provided with a heat sink.

17. The motor drive controller of claim 16, wherein the heat sink is provided with an exterior fan.

18. The motor drive controller of claim 17, wherein the exterior fan is detachable from the heat sink.

19. The motor drive controller of claim 1, wherein the processor is configured to process the received operating instructions and provide an operation status, wherein both are compliant with any one or more of the protocols Ethernet/IP, EtherCAT, ProfiBus and ProfiNet.

20. The motor drive controller of claim 1, further comprising one or more memory modules, wherein each of the memory modules is configured to store unique parameters associated with an assigned function.

21. The motor drive controller of claim 20, wherein the one or more memory modules comprises
a first memory module configured to store operating parameters for the processor;
a second memory module configured to store operating parameters for a motor controller;
a third memory module configured to store operating parameters for an input interface controller; and
a fourth memory module configured to store operating parameters for a field bus interface controller.

22. A network of motor drive controllers comprising
one or more separate sub-systems of motor drive controllers, wherein each of the separate sub-systems comprises a plurality of interconnected motor drive controllers; and
a network controller connected to the one or more separate sub-systems of motor drive controllers, the network controller configured to provide operating instructions to all of the interconnected motor drive controllers, wherein
one or more of the motor drive controllers within each of the one or more separate sub-systems of motor drive controllers is configured to provide operating instructions to each of the other plurality of interconnected motor drive controllers within the respective sub-system of motor drive controllers when the network controller is inactive.
